(19) United States
(12) Patent Application Publication
(10) Pub. No.: US 2023/0333552 A1
(43) Pub. Date: Oct. 19, 2023

(54) METHODS AND SYSTEMS FOR HUMAN-IN-THE-LOOP VEHICULAR COMMAND AND CONTROL USING IMMERSIVE SYNTHETIC VISION

(71) Applicant: Rotor Technologies, Inc., Cambridge, MA (US)

(72) Inventors: Zachary DUGUID, Cambridge, MA (US); Haofeng XU, Cambridge, MA (US); Kristoffer FREY, Cambridge, MA (US); Logan BARNES, Nashua, NH (US); Gregor MCMILLAN, Cambridge, MA (US)

(21) Appl. No.: 18/133,380

(22) Filed: Apr. 11, 2023

Related U.S. Application Data
(60) Provisional application No. 63/330,423, filed on Apr. 13, 2022.

(51) Int. Cl. G05D 1/00; G05D 1/10; G06T 15/20

(52) U.S. Cl. CPC G05D 1/0044; G05D 1/101; G06T 15/20; B64C 27/04

(57) ABSTRACT

The present invention provides a synthetic vision system to support the piloting of a vehicle. The system may comprise: an immersive display screen and/or head-mounted virtual reality display, one or more real-time sources of information from onboard the vehicle (e.g., aircraft), one or more data sources that are not onboard the vehicle, either stored in memory or accessed in real-time via a communications channel, and a computer with a graphics processing unit to combine multiple sources of data and render them in real-time to be shown to the pilot via the synthetic vision system display.

### CROSS-REFERENCE TO RELATED APPLICATIONS

This application claims the priority and benefit of U.S. Provisional Application No. 63/330,423, filed on Apr. 13, 2022, the entirety of which is incorporated herein by reference.

### BACKGROUND

The command and control of moving vehicles is conventionally performed by a human pilot situated onboard the vehicle (an “Onboard Pilot”). This in-vehicle approach to command and control provides for the Onboard Pilot (i) direct control inputs to the vehicle such as through mechanical or hard-wired signal transmission schemes, (ii) direct visual and sensory feedback of the vehicle's state and its environment in real-time creating an intuitive first-person piloting experience, and (iii) the ability to physically affect or repair the vehicle in-situ during operation. However, there are drawbacks to in-vehicle command and control. For example, the vehicle is required to make provision for the security and comfort of the Onboard Pilot, which in performance-constrained vehicles introduces significant engineering and operational burden. Additionally, the Onboard Pilot may be exposed to the environmental risk in which the vehicle operates, which can lead to injury or death in the event of a mechanical failure or crash.

Recently, autonomous or remote approaches for controlling vehicles without an Onboard Pilot have emerged. For example, control may be achieved by replacing the control and decision-making of a human pilot with a set of computer instructions and/or artificial intelligence systems, which we refer to as “AI Mode”, or by providing the means for a human pilot situated outside of the vehicle, a “Remote Pilot”, to effectively control the vehicle using real-time or near real-time communications, which we refer to as “Remote Pilot Mode”. In some cases, a combination of both methods may be used. For example, in a primarily AI Mode system, a Remote Pilot may be used to handle scenarios in which the AI Mode fails or requires higher-level guidance. In another example, a primarily Remote Pilot Mode system may use automation in the lower levels of the control hierarchy to improve mission performance (e.g., precision trajectory following), to reduce pilot workload, or to handle communications delays and dropouts.

A particular challenge in systems with a Remote Pilot Mode component is the Human-Machine Interface (HMI) which conveys information about the state of the vehicle and its environment to the Remote Pilot and receives control commands from the Remote Pilot for operating the vehicle. Conventional HMIs used for in-vehicle piloting may not be suitable for remote piloting: in-vehicle HMIs are usually designed for use in conjunction with direct vision and other sensory inputs available to the Onboard Pilot (e.g., a direct view of the outside through windows in the cockpit). Conventional in-vehicle interfaces include analog dials and instruments for data such as tachometers, speeds, pressures, and temperatures, as well as modern digital displays for navigation, multi-instrument information display, and entertainment. When these or similar interfaces are used for Remote Pilot systems, they are typically combined with ancillary digital displays which show real-time imagery from fixed positions on the vehicle as a substitute for the direct view from the cockpit, resulting in an array of distinct HMI components that the Remote Pilot must assimilate to maintain situational awareness. Due to technology constraints that limit (i) the quality of visual information captured by cameras compared to the human retina, (ii) the quality of data transmitted by the communications channel, which has finite latency, constrained bandwidth, and limited reliability, and (iii) the quality of traditional HMI displays compared to that of direct visual observation, the result is a Remote Piloting capability worse than that of an Onboard Pilot.

### SUMMARY

The need exists for an improved system of vehicle control that can combine multiple information sources, convey them to the pilot in an integrated and intuitive manner, and allow them to effectively command the vehicle and accomplish a diverse set of mission objectives.

Human-Machine Interfaces (HMIs) are important for aircraft piloting for both Remote Piloting and Onboard Piloting use cases; they may significantly improve safety and mission performance, as well as enable flight in challenging conditions. Aircraft piloting can be conducted under two sets of operating rules: Visual Flight Rules (VFR) and Instrument Flight Rules (IFR). The former applies in Visual Meteorological Conditions (VMC), which corresponds to high-visibility conditions away from cloud coverage in day or night. The latter applies to Instrument Meteorological Conditions (IMC), which corresponds to poor-visibility conditions, which are often caused by proximity to cloud coverage, and is sometimes referred to as “degraded visual environments” (DVE). IFR flight is more challenging than VFR flight and requires a higher level of pilot training, aircraft certification, and HMI instrument capabilities. A pilot who is not trained in or expecting IFR flight, or who is flying in an aircraft that is not equipped or certified for IFR flight, may inadvertently fly into IMC. Inadvertent entry into IMC (I-IMC) is a significant source of deadly aviation accidents. Additionally, night VFR flight, especially in the absence of moonlight, starlight, and man-made light sources, is more difficult than daytime VFR flight and represents another significant source of aviation accidents. To enable flight in challenging operating conditions, HMI systems must provide the pilot with sufficient situational awareness of the aircraft and the surrounding environment in the absence of external visual references.

Some current technology solutions use digital displays to improve the situational awareness of onboard aircraft pilots beyond that provided by traditional instruments, particularly in IFR and night VFR conditions. Traditional IFR instruments such as heading indicators, gyroscopic turn indicators, and distance measuring equipment (DME) require high levels of training and demand significant pilot workload during operation. As an alternative, modern systems can display computer-rendered “synthetic vision” of terrain and other objects (e.g., peer aircraft). This can provide a primary source of situational awareness for the pilot in IFR flight and a secondary source of situational awareness in VFR flight. However, in VFR, these synthetic vision features, which are shown to the pilot on a digital display located on the flight deck, may not be well-integrated into the piloting experience because they are separate to the pilot's direct field of view out of the cockpit: in order to refer to the synthetic vision display, the pilot must transition their attention away from the cockpit window, causing a context switch and a partial loss of situational awareness. While existing synthetic vision displays are a major improvement over traditional instruments, they only provide (i) a limited display size since the display panel must fit in the confines of a dashboard without obstructing other instruments or views out of the cockpit, and (ii) a limited quality of visual information displayed due to unsophisticated data inputs (e.g., e.g., a basic static database of terrain, the GPS navigation system, and sometimes the air data computer) and graphic rendering systems.

There are structural limitations that apply to even state-of-the-art HMI and display systems. Many informational and display systems for vehicle control are designed as modular devices, so they can be used in conjunction with other similar devices (e.g., a single needle display dial as part of a larger instrument panel on an aircraft) or installed as a retrofit addition to existing vehicle instruments (e.g., a smartphone-based navigation system for an automobile). These modular devices cannot be integrated seamlessly with other instruments, displays, or the pilot's natural visual field of view out of the cockpit. With increasing numbers of displays and discrete retrofit features added to a vehicle, the vehicle dashboard can become a miscellany of uncoordinated information streams—both analog and digital—resulting in informational overload and pilot disorientation, especially in high-stress or emergency situations.

Furthermore, utilizing multiple discrete displays requires the pilot to fuse multiple discrete sources of data and information. Since each additional display usually has one specific function, its information is usually limited to a single source (e.g., a GPS antenna, a tachometer sensor, or an externally mounted camera). Different displays and interfaces may not be able to exchange information with each other. This segmentation of information sources may result in data inconsistencies or even conflicts. The burden of resolving differences between the information streams, integrating correlating data points, reconciling conflicting ones, and creating a coherent view of the vehicle and its environment is placed on the pilot, causing high pilot workload. In some cases, a pilot may have to reconcile the information displayed on a digital GPS navigation unit with what they are seeing directly out of the window, thereby causing high pilot workload and distraction or even unsuccessful localization.

Some solutions may be adopted to alleviate these problems arising from discrete and fixed-position displays. For example, helmet displays, heads up displays (HUDs), or holographic projections provide an integration with the outside visual field of view. However, these solutions, sometimes referred to as “Augmented Reality” or AR, are limited by physical hardware constraints, costs constraints, or engineering constraints.

Systems and methods of the present disclosure address the above needs by providing an improved HMI framework that uses an immersive synthetic vision system (SVS) to convey multiple streams of information to the pilot in a unified and integrated manner. An SVS displays digitally generated visual graphics without relying exclusively on direct camera observations or views through a cockpit window. Even if direct camera observations are included in the displayed image, an SVS herein may create intermediate digital representations which allow for a more flexible and feature-rich processing and display of information.

In some embodiments, the display elements of the SVS are immersive and provide all the necessary visual input that a pilot may need to perform normal functions. The visual input provided by the immersive SVS may allow for a pilot to perform normal functions during a flight without the need to “look outside” of the SVS (e.g., through the window of the cockpit). The visual input may not overburden the pilot while providing sufficient and necessary information for performing the functions. To ensure this level of immersion without loss of functionality, the SVS has accessible to it the combined information that would otherwise require multiple traditional discrete systems to convey such information. The SVS may process a plurality of information streams and leverage a graphics processing unit (GPU) to create an integrated visual display.

The present disclosure provides a synthetic vision piloting system (SVPS) for the overall command and control of a vehicle. The SVPS may comprise the SVS as described above, a data downlink system for transmitting, processing, and managing the multi-faceted information to be presented to the pilot in the SVS and a data uplink system for turning the Pilot Inputs into a set of useful Vehicle Outputs. The immersive and integrated nature of the SVPS may improve human-machine interactions compared to traditional modular and retrofit HMIs

Unlike traditional modular and retrofit HMIs, the provided immersive-display and integrated-system beneficially allows for the creation of an improved human-machine interaction. Instead of requiring the combining and reconfiguring of physical hardware, the SVS may provide software reconfigurability of the synthetic vision display. The provided hardware HMI component, i.e., the immersive digital display, may be independent of the types of vehicles and may support multiple piloting modes with different types of informational displays (e.g., graphics) for a wide variety of vehicles. This is achieved by graphics and information processing configurations in the software with little need to reconfigure the hardware. Although many of the display systems and methods are described herein with respect to an aircraft, it should be noted that such systems and methods can be applied to any situation where control of a vehicle is desired.

In some embodiments, the display component of the SVS may comprise a head-mounted display which tracks the movement of the pilot's head, eyes, and body to pan and adjust the displayed image, creating an immersive “virtual reality” (VR) display. In some embodiments, the display component comprises fixed displays that create an immersive surround view for the pilot. For example, an immersive view may be provided by selecting the proper size, shape, and arrangement of the display (e.g., horizontal and/or vertical curvature of the display increases the angles at which it can project light to the viewer.)

The SVS and the pilot may be located at a Remote Control Station (RCS) that is remote to the vehicle being controlled. Alternatively or additionally, the SVS and pilot may be located onboard the vehicle.

The systems and methods herein may provide a human-centric system allowing a pilot to perform “end-to-end” or full command and control of a vehicle. In some cases, one or more features of the remote control or SVS may employ artificial intelligence to provide various types of semi-autonomous or fully autonomous operating modes while the human operator is kept in the control loop. In some modes, the human pilot may provide direct control inputs (e.g., manipulating the stick and rudder of an airplane) and in other modes the human pilot may be a passive observer with limited control interaction (e.g., supervising the autonomous operation of a vehicle). The system herein is fundamentally designed to interact with humans, to convey multiple data streams and formats of information to them in a coherent and intuitive way, and to elicit a productive control response or input from the human. The provided systems and methods improve the performance and safety of vehicles by improving their interfaces with humans.

In an aspect, a system is provided for providing synthetic vision to a human operator. The system comprises: a display device disposed at a control station remote from a movable object capable of translational and rotational movement; one or more processors configured to perform operations including: receiving real-time data from one or more data sources and accessing data stored in a local or cloud storage device to construct a virtual view; and rendering the virtual view to the human operator via the display device for controlling an operation of the movable object under Visual Flight Rules (VFR) condition or Instrument Flight Rules (IFR) condition. The virtual view comprises a first-person view (FPV) or a third-person view (TPV) and wherein either the FPV or the TPV comprises at least a rendering of a natural object serving as a reference point to the human operator.

In a related yet separate aspect, a method for providing synthetic vision to a human operator is disclosed herein. The method comprises: providing a display device at a control station remote from a movable object capable of translational and rotational movement; receiving real-time data from one or more data sources and accessing data stored in a local or cloud storage device to construct a virtual view; and rendering the virtual view to the human operator via the display device for controlling an operation of the movable object under Visual Flight Rules (VFR) condition or Instrument Flight Rules (IFR) condition. The virtual view comprises a first-person view (FPV) or a third-person view (TPV) and wherein either the FPV or the TPV comprises at least a rendering of a natural object serving as a reference point to the human operator.

In some embodiments, the movable object comprises a fly-by-wire control system for controlling an actuator of the movable object in response to a command received from the control station. For example, the movable object is a helicopter.

In some embodiments, the virtual view is displayed based on measurements of a movement of the human operator's head and/or eyes. In some embodiments, the real-time data comprise video stream captured by an imaging device onboard the movable object and wherein the natural object is not visible in the video stream.

In some embodiments, the operations further include determining data to be displayed within the virtual view based on the VFR condition or the IFT condition. In some embodiments, the TPV is configurable by changing a virtual TPV camera location. In some embodiments, the operations or the method further includes activating a transparency mode in the TPV when the movable object is approaching a destination.

In some embodiments, the virtual view comprises a rendering of a dynamic obstacle. In some cases, the dynamic obstacle is tracked by processing sensor data collected from movable object. In some instances, a location of the dynamic obstacle is tracked by applying a feed-forward model to the sensor data. For example, an identity of the dynamic obstacle is determined by applying a machine learning algorithm trained model to the sensor data. In some cases, the rendering of the dynamic obstacle is based at least in part on a certainty of the identity and/or the location.

Additional aspects and advantages of the present disclosure will become readily apparent to those skilled in this art from the following detailed description, wherein only exemplary embodiments of the present disclosure are shown and described, simply by way of illustration of the best mode contemplated for carrying out the present disclosure. As will be realized, the present disclosure may be capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIGS. 1A and 1B show an example architecture of a Synthetic Vision System (SVS) for remote control of a vehicle.

FIGS. 2A and 2B show an example architecture for an in-vehicle SVS for control of a vehicle.

FIG. 3 shows examples of aircraft controlled by the methods and systems herein.

FIG. 4 shows an example of an immersive First Person View (FPV) synthetic vision interface with an integrated Heads Up Display (HUD).

FIG. 5 shows an example of an immersive Third Person View (TPV) synthetic vision interface with an integrated HUD.

FIG. 6 shows examples of Overlays including markers for Places of Interest and Hazards in an urban environment.

FIG. 7 shows examples of Overlays that highlight different airspace zones as well as visual reference grids for terrain, water, and free space.

FIG. 8 shows an example of providing real-time weather and environmental visual input on a display.

FIG. 9 shows an example of an elevation-based World Model compared to a hybrid World Model for a low flying aerial vehicle.

FIG. 10 shows an example of a hybrid World Model that utilizes heterogenous datasets to represent the virtual world in the synthetic vision display.

FIG. 11 shows example Views that the Pilot may utilize while operating the Vehicle, including both FPV and TPV Views.

FIG. 12 shows an example of a non-conventional FPV perspective from the bottom of an aerial vehicle which includes a rendering of the vehicle's landing gear in the View.

FIG. 13 shows an example of a TPV with Vehicle transparency mode activated to allow the Pilot to see a landing zone during approach.

FIG. 14 shows an example of a TPV with an inset aerial View and multiple flight instruments included in the HUD.

FIG. 15 shows examples of ground reference Overlays that are placed on top of the World Model, including: elevation contours, text labels, and map imagery.

FIG. 16 shows example Overlays in a TPV including Ground Projection, Take-off Position, and Environmental Lighting.

FIG. 17 shows an example of a Remote Pilot actively piloting a subscale aircraft with the Synthetic Vision Piloting System (SVPS).

### DETAILED DESCRIPTION

The present disclosure provides systems and methods for remote control of movable objects (e.g., vehicles), enabling improved situational awareness (SA) beyond the capabilities of conventional in-vehicle piloting. Systems and methods herein may improve the human-machine interface (HMI) with an immersive synthetic vision capability. The human pilot may be located remotely from the movable object. In some cases, systems and methods herein may also be used when the pilot is located conventionally inside the vehicle and interacts with the vehicle from within an immersive synthetic vision HMI system.

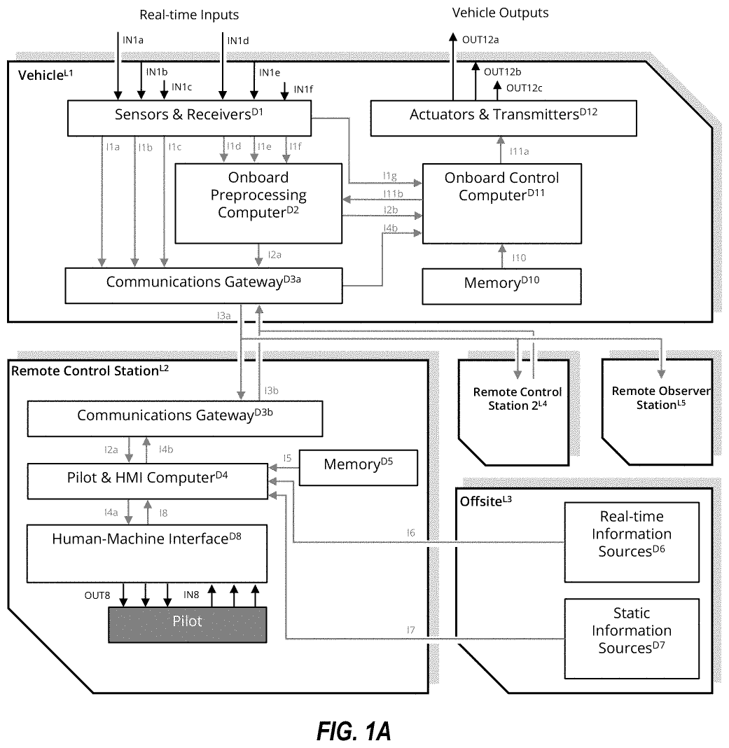

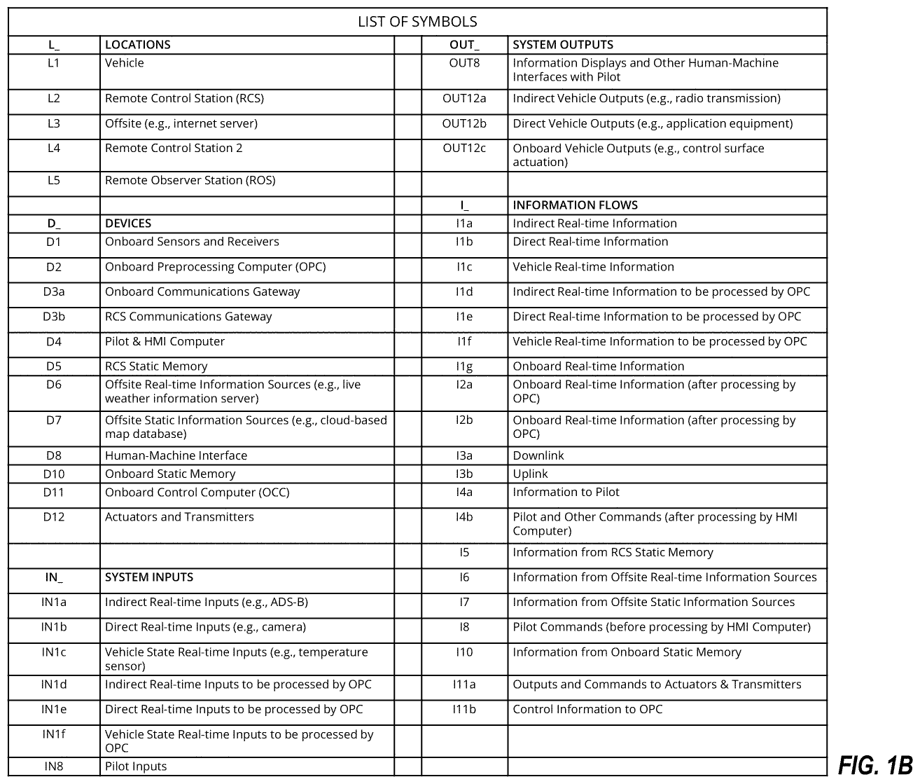

Remote Control Station (RCS). FIG. 1 shows a schematic architecture of the system for remote controlling a vehicle. The system may be used by a human pilot located at a Remote Control Station (RCS) (L2) located remotely from the vehicle. The system may comprise a remote pilot synthetic vision system for vehicular control. In some cases, the remote control station may also be referred to as ground control station. The synthetic vision system may also be referred to as Synthetic Vision Piloting System (SVPS) that enables a Remote Pilot to control a vehicle by providing the pilot with necessary visual and sensory information for performing normal functions and operations. The system may provide improved situational awareness to a Remote Pilot by removing the spatial and visibility constraints of a conventional vehicle cockpits and by leveraging onboard sensors, offboard data sources (e.g., geographic data, weather data, traffic data, etc.), and computer-rendered graphics to generate an integrated and immersive HMI. Onboard sensors might include omnidirectional cameras, radar sensors, lidar sensors, thermal optics, GPS receivers, Inertial Measurement Units (IMUs), and gyroscopic orientation sensors. Offboard data may include geographic elevation, building positions, real-time flight tracking, airspaces, and weather. The fusion of these data sources may beneficially reduce disorientation and other limitations due to physical detachment from the vehicle thereby providing safe and effective operation and navigation. Such improved remote control mechanisms and methods may allow the vehicle to be used in challenging conditions and for complex tasks, such as aerial firefighting, power line inspection, agriculture, and urban air mobility.

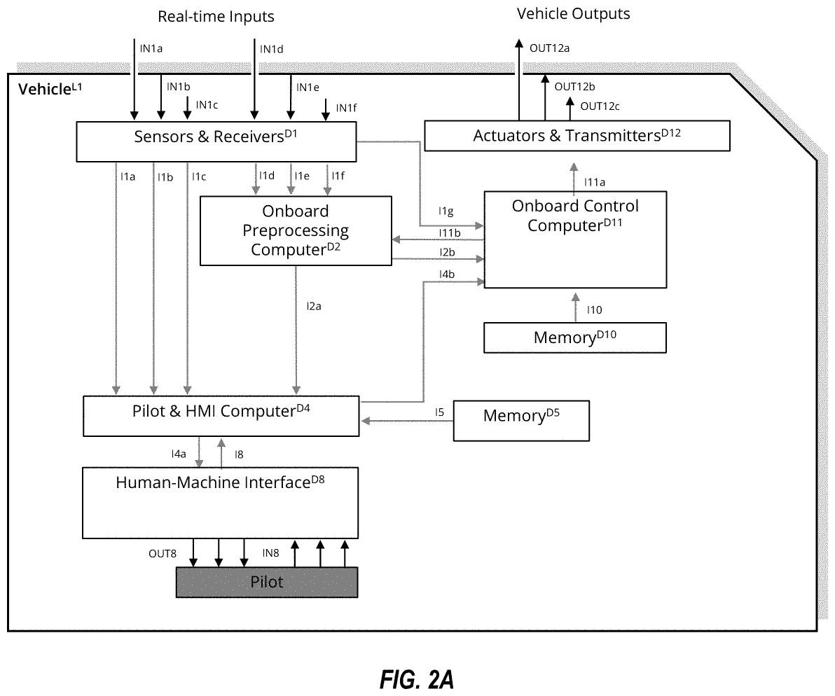

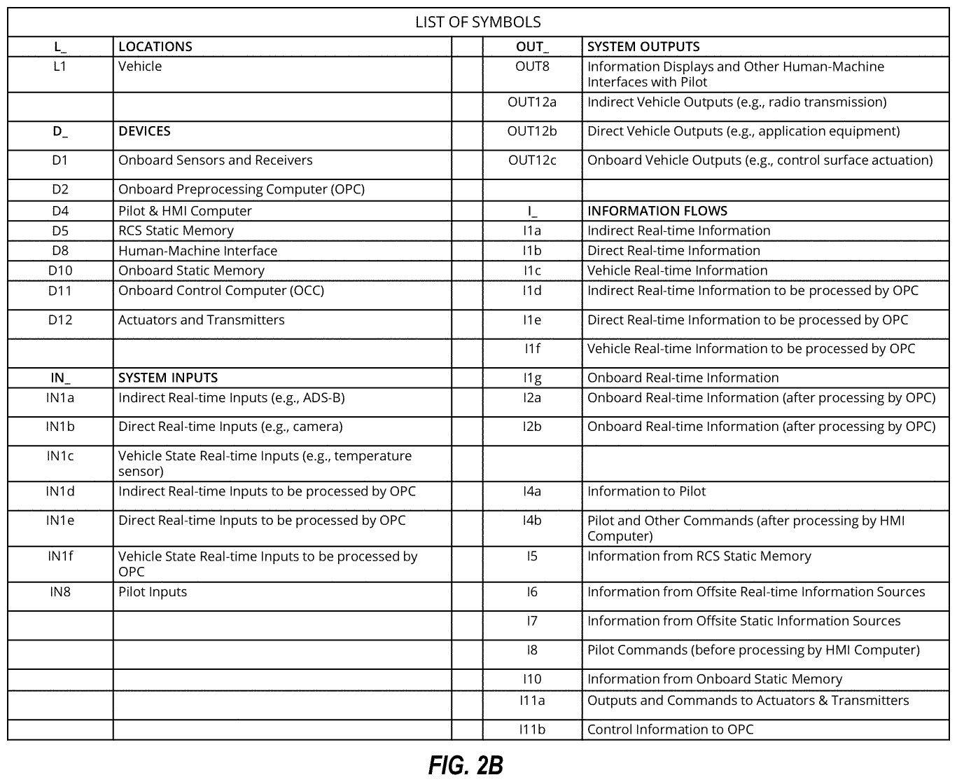

Onboard Pilot. FIG. 2 shows an example of a SVPS for in-vehicle piloting. The SVPS may be located onboard the Vehicle (L1). In some cases, the SVPS for in-vehicle piloting may not include a Communications Gateway for transmitting information between the vehicle and the RCS (remote control station). The latency of the SVPS in this situation may be lower since wireless communications is no longer required. In some cases, the onboard pilot may be immersed entirely within the Synthetic Vision System (SVS) onboard the vehicle. The pilot may not need windows to view the external environment, even if such a view is available on the vehicle. This beneficially allows for vehicles to be designed without windows since situational awareness is maintained through digitally-displayed visuals in the SVPS virtual view.

Co-Pilots and Observers. The SVS may provide information to a primary pilot who actively controls the movement of the vehicle; it may also provide information to a co-pilot or operator who may not actively control the vehicle. The co-pilot or operator may be co-located with the primary pilot, or in a separate location. In some cases, the co-pilot may interchangeably share duties with the primary pilot during the mission. In some cases, the co-pilot may be responsible for some vehicle command and control. These duties may include navigation, sensor operation, system diagnostics, or operation of application equipment, such as operating a sling load, a multi degree of freedom robotic arm, or a bulldozer nose piece. The SVS may also provide information to a passive observer who is not involved in the operation of the vehicle. The term “pilot” as utilized herein, may generally refer to the primary pilot, the co-pilot or the observer who may all be users of the SVPS unless the context suggests otherwise.

Multiple RCSs. As shown in FIG. 1, the systems herein may be used for multiple RCSs. For instance, one or more pilots may be located at any of the RCSs (L2, L4, and L5). The system herein may comprise a communication mechanism such that the multicasting of information to multiple RCSs and the multiplexing of commands from multiple pilots can be unlimited. The plurality of RCSs may provide different levels of control of the vehicle. For example, some RCSs may allow a small number of pilots to perform active command and control, while other RCSs may display information to many passive observers who may be geographically distributed around the world. Piloting duties may be handed off between different pilots and between different RCSs during the mission.

Vehicle Degrees of Freedom. The vehicle may be capable of moving freely within the environment with respect to six degrees of freedom (e.g., three degrees of freedom in translation and three degrees of freedom in rotation). Alternatively, the movement of the vehicle may be constrained with respect to one or more degrees of freedom, such as by a predetermined path, track, or orientation. The movement can be actuated by any suitable actuation mechanism, such as an engine or a motor. The actuation mechanism of the vehicle can be powered by any suitable energy source, such as chemical energy, electrical energy, magnetic energy, solar energy, wind energy, gravitational energy, nuclear energy, or any suitable combination thereof. The vehicle may be self-propelled via a propulsion system, as described elsewhere herein.

Examples of Vehicles. Systems herein may be used to remote control any type of vehicles which may include water vehicles, aerial vehicles, space vehicles, or ground vehicles. For example, aerial vehicles may be fixed-wing aircraft (e.g., airplane, gliders), rotary-wing aircraft (e.g., helicopters, multirotors, quadrotors, and gyrocopters), aircraft having both fixed wings and rotary wings (e.g. compound helicopters, tilt-wings, transition aircraft, lift-and-cruise aircraft), or aircraft having neither (e.g., blimps, hot air balloons). A vehicle can be self-propelled through the air, water, space, or over ground. A self-propelled vehicle can utilize a propulsion system that includes one or more engines, motors, wheels, axles, magnets, rotors, propellers, blades, nozzles, or any suitable combination thereof.

Vehicle Size and Dimensions. The vehicle can have any suitable size and/or dimensions. In some embodiments, the movable object may be of a size and/or dimensions that allow a human occupant to reside within or on a vehicle. Alternatively, the vehicle may be of size and/or dimensions smaller than that capable of having a human occupant within or on the vehicle. The vehicle may be of a size and/or dimensions suitable for being lifted or carried by a human. Alternatively, the vehicle may be of larger size and/or dimensions suitable for being lifted or carried by a human.

Vehicle Propulsion. The vehicle propulsion mechanisms can include one or more rotors, propellers, blades, engines, motors, wheels, axles, magnets, or nozzles, based on the specific type of vehicle. In some instances, the propulsion system can be used to enable the movable object to take off from a surface, land on a surface, maintain its current position and/or orientation (e.g., hover), change orientation, and/or change position. The propulsion system may run on an energy source, such as electrical energy, magnetic energy, solar energy, wind energy, gravitational energy, chemical energy, nuclear energy, or any suitable combination thereof. In some cases, the propulsion mechanisms can enable the vehicle to take off vertically from a surface or land vertically on a surface without requiring any horizontal movement of the vehicle (e.g., without traveling down a runway). Optionally, the propulsion mechanisms can be operable to permit the vehicle to hover in the air at a specified position and/or orientation.

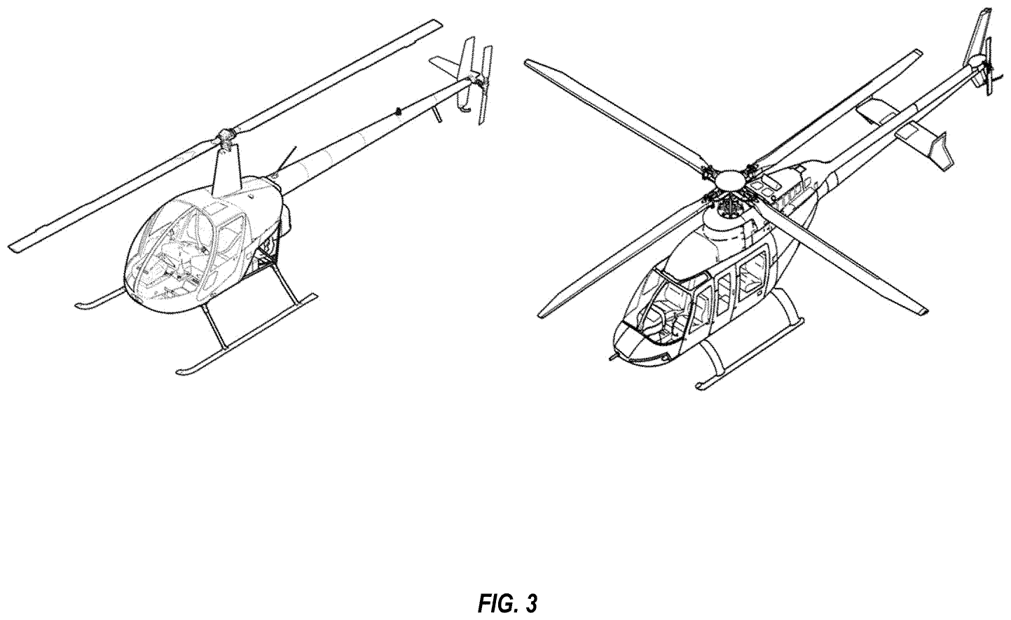

Aircraft Vehicle. In some embodiments, the vehicle may be a vertical takeoff and landing aircraft or helicopter. FIG. 3 shows examples of aircraft controlled by the methods and systems herein. In some cases, the aircraft may be powered by liquid hydrocarbon fuel. In some cases, the aircraft may comprise a single-engine architecture or multi-engine architecture. In some cases, the aircraft may comprise a swashplate-based rotor control system that translates input via the helicopter flight controls into motion of the main rotor blades. The swashplate may be used to transmit the pilot's commands from the non-rotating fuselage to the rotating rotor hub and main blades. Although the vehicle is depicted as an aircraft, this depiction is not intended to be limiting, and any suitable type of movable object can be used, as described elsewhere herein. One with skill in the art would appreciate that any of the embodiments described herein in the context of aircraft systems can be applied to any suitable movable object (e.g., a spacecraft, naval, or ground craft).

Types of Real-time Input. Referring back to FIG. 1, a vehicle may have Real-time Inputs (IN1). The Real-time Inputs may comprise information streams that vary with time depending on the state of the vehicle, its position, and its surroundings, as well as other time-dependent factors. In some embodiments, the Real-time Inputs may comprise Indirect Real-time Inputs (IN1a/IN1d), Direct Real-time Inputs (IN1b/IN1e), and/or Vehicle State Real-time Inputs (IN1c/IN1f). All the Real-time Inputs that are sensed or received by the aircraft that are then transmitted to the pilot may be collectively referred to as “telemetry”.

Indirect Real-time Inputs. A vehicle may have Indirect Real-time Inputs (IN1a/IN1d). The Indirect Real-time Inputs may comprise information streams that are received by the vehicle and may not comprise direct sensor observation data or measurement data from the vehicle. The Indirect Real-time Inputs may include, for example, peer-to-peer broadcast of information streams or communications that are received by the vehicle, dynamic weather and turbulence updates, and changes to mission objectives. Such Indirect Real-time Inputs may or may not be received separately by the RCS. In some cases, the Indirect Real-time Inputs may include ADS-B, wireless communications with external parties other than the RCS such as analog voice communications, digital voice communications, digital RF communications, MADL, MIDS, and Link 16. The Indirect Real-time Inputs may not be transmitted to the RCS by default, or they may be transmitted to the RCS on-demand. For example, the Indirect Real-time Inputs may be transmitted to the RCS upon a request when the RCS cannot receive the inputs from another party (e.g. if the RCS is out of range of two-way radio communications with a third-party control tower while the vehicle is not). Alternatively, Indirect Real-time Inputs may not be transmitted to the RCS when the information is only needed for processing and decision-making onboard the vehicle itself (e.g. using ADS-B data to support an onboard detect and avoid system).

Direct Real-time Inputs. A vehicle may have Direct Real-time Inputs (IN1b/IN1e). The Direct Real-time Inputs may comprise information streams that are directly observed or measured by the vehicle (e.g., sensors onboard the vehicle, sensors offboard the vehicle) about its environment and surroundings. Some examples of types of sensors that provide Direct Real-time Inputs may include location sensors (e.g., global positioning system (GPS) sensors, mobile device transmitters enabling location triangulation), vision sensors (e.g., imaging devices capable of detecting visible, infrared, or ultraviolet light, such as cameras), proximity or range sensors (e.g., ultrasonic sensors, lidar, time-of-flight or depth cameras), altitude sensors, attitude sensors (e.g., compasses), pressure sensors (e.g., barometers), temperature sensors, humidity sensors, particle analysis sensors (e.g., mass spectrometers), audio sensors (e.g., microphones), field sensors (e.g., magnetometers, electromagnetic sensors, radio sensors), and various others.

Direct Real-time Inputs: Multi-camera. The Direct Real-time Inputs may comprise data captured by one or more imaging devices (e.g., cameras). The imaging devices may comprise one or more cameras configured to capture multiple image views simultaneously. For example, the imaging devices may comprise a first imaging device and a second imaging device disposed at different locations onboard the vehicle relative to each other such that the first imaging device and the second imaging device have different optical axes.

Vehicle State Real-time Inputs. The vehicle may have Vehicle State Real-time Inputs (IN1c/IN1f), which are information streams that are related to the Vehicle's own state. Some examples of types of sensors that provide Vehicle State Real-time Inputs may include inertial sensors (e.g., accelerometers, gyroscopes, and/or gravity detection sensors, which may form inertial measurement units (IMUs)), temperature sensors, magnetometers, Global Navigation Satellite System (GNSS) receivers, fluid level and pressure sensors, fuel sensors (e.g., fuel flow rate, fuel volume), vibration sensors, force sensors (e.g., strain gauges, torque sensors), component health monitoring sensors (e.g., metal chip detectors), microswitches, encoders, angle and position sensors, status indicators (e.g., light on/off) and various others that can help determine the state of the vehicle and its components. This is separate to the Direct Real-time Inputs which provide situational awareness of the vehicle's surroundings (although there is of course an inevitable coupling and overlap between the two).

Vehicle State Real-time Inputs: Pilot State. In some cases, information about the pilot state may be provided as an extension of the Vehicle State Real-time Inputs. The pilot state data streams may include the pilot's head, eye, and body positions, along with the pilot's health and attention metrics. These pilot state Real-time Inputs may enable adaptive HMI elements to update the synthetic vision display to match the gaze direction of the pilot. In some cases, the SVS may be configurable via head, eye, and body position movements. Additionally, other health data of the pilot may be monitored to assess fatigue, distraction, and general readiness to actively operate a vehicle. For example, upon detecting the pilot to be unable to actively operate a vehicle, the system may switch to an autonomous safety mode such as auto-land or auto-hover maneuvers in the case of aerial vehicles.

Real-time Inputs: VFR and IFR Flight. In some cases, the vehicle data sources may be selected such that the data that is necessary and sufficient to enable flight under Visual Flight Rules (VFR) is collected and/or transmitted. For example, for flight under VFR, the vehicle data sources for the aircraft may comprise: an airspeed indicator, an altimeter, a magnetic direction indicator, a tachometer for each engine, an oil pressure gauge for each engine using a pressure system, a temperature gauge for each liquid-cooled engine, an oil temperature gauge for each air-cooled engine, a manifold pressure gauge for each altitude engine, a fuel gauge indicating the quantity of fuel in each tank, and a landing gear position indicator. In some cases, the data sources may be selected such that the data that is necessary and sufficient to enable flight under Instrument Flight Rules (IFR) is collected and/or transmitted. Such vehicle IFR data sources may comprise: (i) two way radio communication and navigation equipment, (ii) vehicle telematics data such as gyroscopic rate-of-turn indicator, slip-skid indicator, altimeter adjustable for barometric pressure, digital clock (e.g., hours, minutes, and seconds), gyroscopic pitch and bank indicator, gyroscopic direction indicator, (iii) external data sources such as weather data (e.g., weather at the vehicle site), (iv) airport visibility minimums and maximums, alternate landing locations, (v) and other requirements stipulated by the FAA or other applicable governing body.

Processing of Real-time Inputs. At least a portion of the Real-time Inputs (IN1a/IN1b/IN1c) may be passed directly to the Communications Gateway (D3a) with no or minimal processing by the preprocessing computer. The preprocessing computer may perform data processing such as aggregation, synchronization, filtering, smoothing, downsampling and the like. In some cases, at least a portion of the Real-Time Inputs (IN1d/IN1e/IN1f) may be processed in an Onboard Preprocessing Computer (D2) which performs more involved data processing operations before passing the results to the Communications Gateway. For example, the Onboard Preprocessing Computer may automatically detect conditions of the flight environment, identify and classify obstacles, reduce the quantity of data required to be transmitted to the RCS through the Communications Gateway (e.g. compression or downsampling to reduce the amount of data or object detection to enable the transmission of semantic data rather than image or other “raw” data), increase the quality of the data, reduce uncertainty, enable modeling and prediction, detect faults and inconsistencies, or combine multiple data sources.

Processing of Real-time Inputs: Video Stitching and Registration. For multi-camera systems, the video streams may require stitching and registration, which is performed by the Onboard Preprocessing Computer (D2). In some embodiments, video streams from onboard cameras may be combined such that the resulting field of view is greater than that of a single camera. For instance, the video streams transmitted to the RCS may be used to construct a 720-degree surround image to a pilot without any occlusions. The stitching algorithm may be based on known or measured camera positions and calibration parameters for lenses and optical properties, or it may be based on content-aware and feature-based stitching which uses key points or intensity to stitch multiple images (e.g., images of multiple views) together. A combination of these stitching methods may be used to provide robust and optimal stitching in diverse optical conditions. Registration may similarly be performed through a combination of calibration-based and feature-based methods to project images into a consistent coordinate system. This may be used to combine the data from imaging systems that operate in different wavelengths (e.g., IR and visible wavelength) into a coherent dataset. Stitched and registered image data may be projected onto any number of projections, such as equirectangular or cubemap projections.

Processing of Real-time Inputs: Video Encoding. The Onboard Preprocessing Computer (D2) may encode the stitched, registered, or raw video data. The encoding may be performed on a frame-by-frame basis (i.e., image encoding), or on a continuous stream of frames (i.e., video encoding) to reduce the bandwidth or other communications requirements on the Communications Gateway (D3). The encoding algorithm may comprise correlating the raw video data obtained by one or more imaging devices and reducing information redundancy in the raw video data. The raw video data may be encoded substantially in or near real-time as the raw video data is being captured by the one or more imaging devices.

Processing of Real-time Inputs: Object Detection and Feature Extraction. The Onboard Processing Computer (D2) may extract features or detect objects in the video stream using computer vision or machine learning methods. This semantic extraction of data from the image streams onboard the vehicle may comprise key information (I2b) (e.g., detected object, features, etc.) that is important for object detection and collision avoidance (e.g., detecting hazards, other vehicles) and this data may be directly passed to an Onboard Control Computer (D11). The Onboard Control Computer may act upon this information by maneuvering to avoid detected hazards or preventing the pilot from advancing towards them. The avoidance maneuver may be calculated by trajectory planning and optimization methods such as model-predictive control. Other key information generated by the semantic extraction process may be pertinent to the sensing and mission goals of the operation, such as environment monitoring (e.g., fire mapping during aerial firefighting), site selection, or terrain mapping. The key information (I2a) may be transmitted to the pilot in the RCS via the Communications Gateway (D3). In some embodiments, the machine vision system may employ physics models with object permanence (e.g., objects that can be modeled with known physical properties).

Processing of Real-time Inputs: Advanced Tracking. In some embodiments, the SVPS may be capable of tracking movable objects in the view. In some cases, the SVPS may employ feed-forward models to estimate the location of objects even when they may not be detected by the sensors (e.g., camera, lidar, infrared camera, etc.). For example, the SVPS may track an object over time using a Kalman filter, an extended Kalman filter, or another complementary filter. If the available sensors or detection algorithms fail to detect or recognize a tracked object in a single frame (e.g., view is blocked by a cloud), such feed-forward models may allow the SVPS to predict the current state of the object (e.g., propagate the latest prediction over time and provide a “best guess” for where the object may reappear). In some cases, the Kalman filter may use a constant velocity model to represent the dynamics of the target motion. In some cases, when occlusion occurs in nonlinear motion scenarios, conventional algorithms may fail to continuously track multiple moving objects of interest. In some cases, the SVPS may employ a nonlinear tracking algorithm to account for the ambiguity caused by the occlusion among multiple moving objects. In some cases, the nonlinear tracking algorithm may comprise applying an unscented Kalman filtering (UKF) technique to track both linear and nonlinear motions with the unscented transform. The UKF may estimate the velocity information for each object to assist the object detection algorithm, effectively delineating multiple moving objects of occlusion for reliable object detection and tracking.

Processing of Real-time Inputs: Tracking Uncertainty. In some embodiments, uncertainties about the detected object (e.g., location or properties of the object) or uncertainties of the vehicle itself may be provided by the Onboard Preprocessing Computer. For instance, the uncertainties of objects (e.g., location or properties of object) tracked by the SVPS may be mathematically computed such as based on the Kalman filter covariance matrix. The uncertainty information about the object or one or more properties of the object (e.g., location, identity, shape, etc.) may be displayed to the pilot. For example, if the identity of an object is certain but the location is uncertain, such uncertainty may be displayed as semi-transparent uncertainty regions which are overlaid on the virtual image. In another example, if the identity of an object is uncertain but the location is certain, then the object may be displayed with a shape that is semi-transparent at the detected location. This beneficially allows the pilot to conveniently visualize and understand the uncertainty pertaining to the detected objects in the environment.

Communications Gateway. The Communications Gateway (D3) provides a reliable wireless communications channel with sufficient bandwidth and minimal latency to transmit data from Vehicle Real-time Inputs or data that has been processed by the Onboard Preprocessing Computer. Depending on the application and the physical distance between remote operator and aircraft, the channel may be a direct line-of-sight or beyond line-of-sight point-to-point electromagnetic communications channel or, the channel may employ a more complex communications scheme reliant on a network of ground-based or satellite-based nodes and relays. The communications channel may also use the internet as an intermediate network. The Communications Gateway may comprise physical communications channels that have different bandwidth, latency, and reliability characteristics, such as RF link, Wi-Fi link, Bluetooth link, and cellular links. The communications channels may employ any frequency in the electromagnetic spectrum, either analog or digital, and they may use spread spectrum frequency hopping techniques. The Communications Gateway may switch automatically between these channels according to their availability and performance throughout the duration of the mission, and the gateway may negotiate with the Onboard Preprocessing Computer to determine the priority of data to send to the RCS.

Communications Downlink. The data transmitted via the downlink from the vehicle to the RCS may depend on the state and location of the vehicle, the mission requirements, the operating mode, the availability and performance of the communications channels, and the type and location of the RCS. For example, based on the availability and performance of the communication channels (e.g., bandwidth, range), a subset of the Real-time Inputs may be selected and processed by the Onboard Preprocessing Computer and transmitted via the downlink to the RCS (e.g., for pilot situational awareness, control, telemetry, or payload data).

Communications Uplink. The data transmitted via the uplink from the RCS to the vehicle may depend on the state and location of the vehicle, the mission requirements, the operating mode, the availability and performance of communications channels, and the type and location of the RCS. The data may comprise control inputs from the pilot, payload data, software updates, and any other information that is required by the Onboard Control Computer. Control inputs from the pilot can include the pitch, roll, yaw, throttle, and lift inputs which control the digital actuators on the aircraft, as well as digital toggles for controls such as lights, landing gear, radio channels, camera views, and any other pilot-controlled aircraft settings.

Vehicle Digital Control, Actuation, and Information Transmission System. The SVPS system comprises a framework for delivering outputs or Vehicle Outputs onboard the vehicle through Actuators and Transmitters (D12). This includes fly-by-wire or drive-by-wire actuation of vehicle control surfaces that uses digital signals to drive electro-mechanical, electro-hydraulic, and other digital actuators (“Onboard Vehicle Outputs” OUT12c). The outputs of the vehicle can include “Direct Vehicle Outputs”, which generally correspond to mission and application equipment (e.g., payload delivery systems for cargo transport, water delivery systems for firefighting, and agricultural spray systems). Various Direct Vehicle Outputs may also be related to features for the carriage of passengers, such as environmental control systems, ejection systems, and passenger transfer systems. The outputs of the vehicle can also include “Indirect Vehicle Outputs”, which may include the transmission of voice data to air traffic control, or other broadcast and point-to-point information transmission to third parties.

Fly-by-wire Aircraft Actuation. In some embodiments, the vehicle may be an aircraft and may comprise a fly-by-wire actuation of vehicle control surfaces. The fly-by-wire systems may interpret the pilot's control inputs as a desired outcome and then calculate the control surface positions required to achieve that outcome. For example, applying left rotation to an airplane yoke may signal that the pilot wants to turn left. To perform a proper and coordinated turn while maintaining speed and altitude, the rudder, elevators, and ailerons are controlled in response to the control signal using a closed feedback loop.

Pilot and HMI Computer. The primary purpose of the Onboard Preprocessing Computer (D2) is to manage the Vehicle Real-time Input data and its transmission via the Communications Gateway (D3), with data compression and encoding as important functions. The Pilot and HMI Computer (D4) located at the RCS may be configured to decode the Real-time Inputs transmitted from the vehicle and combine them with other real-time and static data sources from Offsite (L3) locations and from onsite Memory (D5). The Pilot and HMI Computer may generate the graphics and manage the display of information to the pilot via an immersive HMI. The HMI may include devices such as joysticks, buttons, pedals, levers, and/or motion simulation devices, that are not vision-based. The Pilot and HMI Computer may be configured to receive the pilot inputs from the HMI devices and then transmit them to the Vehicle via the Communications Gateway (D3). The Pilot and HMI Computer may process some of the pilot inputs to allow for greater automation or to handle potential latency from the Communications Gateway (D4). In the case of latency, the pilot inputs may be used to update the state of the SVPS display by simulating vehicle dynamics before the state is confirmed by the vehicle telemetry. In the case of automation, the pilot may initiate a process which may cause the Pilot and HMI Computer to send a coordinated sequence of commands to the vehicle without the pilot having to perform each step manually. For example, when starting the Vehicle, the pilot may press a “Start Vehicle” button which triggers the Pilot and HMI Computer to send a series of start-up commands while performing safety checks (e.g., check proper engine pressure and temperature).

Immersive HMI for Piloting. The SVPS may provide the necessary information required for piloting while creating an integrated and optimized user interface experience. The necessary information provided by the HMI may be sufficient for a pilot to operate the vehicle without the need for any additional instruments or displays. The necessary information provided by the HMI may enable vehicle operation without overburdening the pilot. The necessary information may include airspeed, altitude, heading, engine RPMs, rotor/propeller RPMs, oil pressure, engine temperature, oil temperature, manifold pressure, fuel quantity, landing gear position, radio communication frequencies, rate of turn, slip/skid turn feedback, time, pitch, bank, direction, weather data, airport visibility restrictions, and potential landing locations. The necessary information for a pilot to conduct normal vehicle operations may be dynamic. For example, operational parameters such as aircraft RPMs, pressures, and temperatures are usually expected to stay within a certain range. If these parameters are operating within the expected ranges, such status information may not be displayed in detail to the pilot. When the parameters approach the limits of their respective normal operating ranges, more details and warning indicators may be displayed to the pilot indicating that action needs to be taken. In another example, when the pilot is flying under VFR conditions, data that is required for IFR but not for VFR such as airport visibility restrictions and alternate airports may not be displayed.

Adaptive HMI. In some embodiments, the human-machine interface (HMI) (D8), may be adaptive to passive pilot input. For example, the HMI system may dynamically display information based on measurements of the pilot's body position such as head and eye movement. In some embodiments, the HMI system herein may comprise displays that are fixed to the RCS. In some cases, a VR display may be fixed relative to the pilot's head and render images according to pilot head movements, providing an immersive viewing experience without the need for large, fixed displays. In some cases, the pilot's head movement of the display device and/or eye movement may affect the transmission, processing, and display of the rendered data. For example, only the video data corresponding to the view where the pilot is currently looking may be processed and/or transmitted, thereby reducing communication bandwidth consumption.

Wearable HMI Display. The SVPS display device may include a wearable device. For example, the display device may be configured to be worn by the pilot. In some cases, the display device may be a pair of glasses, goggles, or other head-mounted display. The display device may include any type of wearable computer or device incorporating augmented reality (AR) or virtual reality (VR) technology. AR and VR involve computer-generated graphical interfaces that provide novel methods for users to experience content. In AR, the graphical interface may be superimposed over images on a display device, where in VR, a user may be immersed in a computer-generated environment rendered on a display device. The display device provided herein may be configured to display a first-person view (FPV) or third-person view (TPV), in either AR or VR contexts.

HMI Force Feel and Motion Feedback. In some embodiments, the RCS may comprise a simulated cockpit of the vehicle. Within the simulated cockpit, the vehicle telemetry data may be communicated to the pilot via haptic feedback such as the motion of their seat and resistance of the corresponding controls (i.e., “force feel” or “force feedback”). In some cases, vehicle telemetry including vehicle orientation and accelerations may be communicated through the moving pilot seat that is capable of up to six-axis motion. In some cases, haptic feedback on stick and rudder cockpit-style controls may communicate forces and torques experienced by the vehicle in real time. Simultaneously, the Pilot Input commands of the cockpit-style controls may be transmitted back to the vehicle via the communications channel.

HMI Auditory Feedback. In some embodiments, the immersive HMI may include auditory feedback for the pilot. Auditory feedback may be utilized to warn the pilot of dangerous operating conditions, assist the pilot with navigation or other mission objectives, enable communication and collaboration with other agents in the environment, or inform the pilot of vehicle or environment state. For warning systems, auditory feedback may be designed to immediately capture the attention of the pilot for immediate action. For informational systems, auditory feedback may be designed to passively transmit information to the pilot without requiring their immediate attention. In some cases, for Remote Pilots, auditory feedback may be designed to emulate the sounds that an in-vehicle pilot may experience. For example, with aerial vehicles, in-vehicle pilots are accustomed to listening to the engine and rotor RPMs during flight. If the RPMs suddenly deviate from the nominal state, the pilot is immediately alerted via auditory feedback, and they can readily take action to respond to the situation. Including auditory feedback in the immersive HMI may beneficially allow Remote Pilots that have in-vehicle piloting experience to leverage their full body of knowledge and instincts while operating the vehicle.

Intuitive Display Elements. In some cases, a portion of the information may be provided in a manner simulating the in-vehicle experience. In some cases, at least a portion of the information may be provided in an improved presentation or an intuitive manner. Some of the information may be consolidated into single display items. For example, a 3D model of the aircraft rendered in a 3D environment may intuitively convey the vehicle's pitch, bank, and direction without needing a full, ranged display item for each attribute.

Digital Twin for Synthetic Vision. The SVPS may leverage a Digital Twin, a virtual representation of the world that leverages geographic information system (GIS) technologies to manage and store the spatial data that constitutes the virtual world, to enable immersive synthetic rendering in the SVS display. The Digital Twin may include information that is stored Offsite (L3) and/or locally in Memory (D5). The Digital Twin may leverage numerous sources of information to represent the virtual world, including data derived from Real-time Inputs. In some embodiments, the Digital Twin may utilize a centralized or distributed spatial database architecture, that may be accessible Offsite and/or locally in Memory, to enable efficient, safe, and organized access to spatial data such that the data may be readily processed and rendered in the SVS display. In some embodiments, the Digital Twin may employ cloud storage and cloud compute technologies when working with large spatial datasets. Due to rendering and display challenges that may occur when working with large spatial datasets, the Digital Twin may provide a geographic subset of the virtual world to the SVS display dynamically. For instance, the Digital Twin may display a subset of the virtual world objects at any given time based the objects' type and spatial proximity to the vehicle. For example, environmental assets, such as fixed obstacles and terrain, that are beyond a specified distance to the vehicle may not be rendered in the virtual world. As the vehicle navigates through the world, the set of environment data rendered in the SVS display may be updated to reflect the vehicle's current position. The information contained in the Digital Twin may be visualized in HUD or Overlay display elements, contributing to an immersive HMI piloting experience. More details regarding the data sources utilized for creating a virtual representation of the world are described later herein.

Offsite and Stored Information Sources. One powerful feature of the RCS is its ability to reliably draw on information sources stored Offsite (L3, e.g., from the cloud) and in local Memory (D5). This data can be updated in real-time, such as in the case of Real-time Input data derivatives, weather conditions, traffic data, and mission logistics data. Alternatively, this data can be static (or infrequently updated), such as in the case of the location of geographical features, terrain data, and manmade structures.

Information Sources for Synthetic Vision. The data for generating synthetic vision may be from a variety of sources. In some cases, the data for generating virtual views of a synthetic vision system may comprise real-time and/or forecast weather data obtained from public data sources, databases stored in a local memory or accessed in real time. In some cases, terrain elevation, terrain point clouds, satellite imagery, and other GIS datasets related to the environment may be retrieved from public data sources to represent a virtual World Model. In some cases, real-time or forecasted weather conditions may be retrieved from public data sources to represent the current atmospheric conditions. In some cases, airports, buildings, roads, points of interest, land use types, and other GIS datasets related to infrastructure may be obtained from a Jeppesen database, OpenStreetMap, Google Maps, or other suitable database. In some cases, data related to aviation, air traffic control, and other collision avoidance data (e.g., ADS-B) may be obtained. In some cases, data used for path planning or flight planning such as TIS-B (shared by FAA), Cooperative (peer-to-peer) ADS-B, and collision avoidance data from drone operators, may also be obtained. The data may be obtained from data sources such as a central database via peer-to-peer network or received as broadcast from the ground/satellites. In some cases, maps (or map-type objects such as buildings and/or natural terrain e.g., valleys, mountains) or terrain data may be pre-stored in the storage device local to the GCS so that the video data for rendering the virtual view may not be necessary to stream, In some cases, dynamic or movable obstacles that may be amorphous and change over time (e.g., a flock of birds, other aerial vehicles) may be detected in real-time and then visualized in the SVS display in the form of virtual representation. For instance, a pre-stored imagery representation of a bird or aerial vehicle may be displayed at a location that is detected and updated in real-time.

Data Fusion and Perception. In some cases, data from multiple sensing modalities or data sources may be dynamically fused based on a real-time confidence level/score or uncertainty associated with each modality. In some cases, real-time imaging (e.g., live camera) data may be used to provide corrections to the prestored World Model data, thereby enhancing the localization accuracy. In some cases, the SVPS may utilize machine learning and AI technologies (e.g., intelligent fusion framework) to optimize the fusion of data from multiple sources. For example, input features to a deep learning model may comprise visible or infrared image data, time-of-flight lidar or radar data, or radiometry or photometry data. In some cases, an output of the deep learning model may be a detected object along with a probability distribution of its physical position in 3D space (e.g., physical location in 3D space and associated confidence score). In another example, the input features may comprise the data obtained from multiple remote sensing observations, along with static geometric data, and the output may be a 3D model of nearby objects and terrain. In some cases, preprocessing algorithms may be applied to generate the input features. In some cases, model prediction may be an iterative process where the data undergoes multiple passes through machine learning frameworks. In some cases, an image-based algorithm may detect object types using 2D camera and object ranges using a radar sensor. These detected objects may then be mapped onto one another to provide information about types of objects and their locations in the environment.

Data Fusion and Perception: Machine Learning. The intelligent fusion framework may include one or more predictive models trained using any suitable deep learning networks. The deep learning model may be trained using supervised learning or semi-supervised learning. In some cases, the intelligent fusion framework may assess the confidence score for each data source and determine the input data to be used for rendering objects in the SVS virtual view. For example, when the quality of the sensor data is below a threshold to identify the location of an object, the corresponding modality may be assigned a low confidence score. In some cases, the intelligent fusion framework may weigh the data from multiple sources based on the confidence score. The detected information may be rendered in the SVS display using the confidence score to alter the display. For instance, objects detected with a low confidence score may be displayed as generic shapes, and objects detected with a high confidence score may be displayed with a 3D rendering model. The 3D rendering model may be generated based on the real-time sensor data (e.g., image data) and/or pre-stored 3D models (e.g., a pre-stored 3D model is retrieved based on an identity of the detected object). In some cases, the movement behavior or trajectory history of an object may also be used to determine the identity of the object. In some cases, the longer an object is tracked, the more information can be inferred. For example, in addition to the identity, shape and size of the object, information such as the predicted direction of travel and speed may be inferred and displayed in the SVS display.

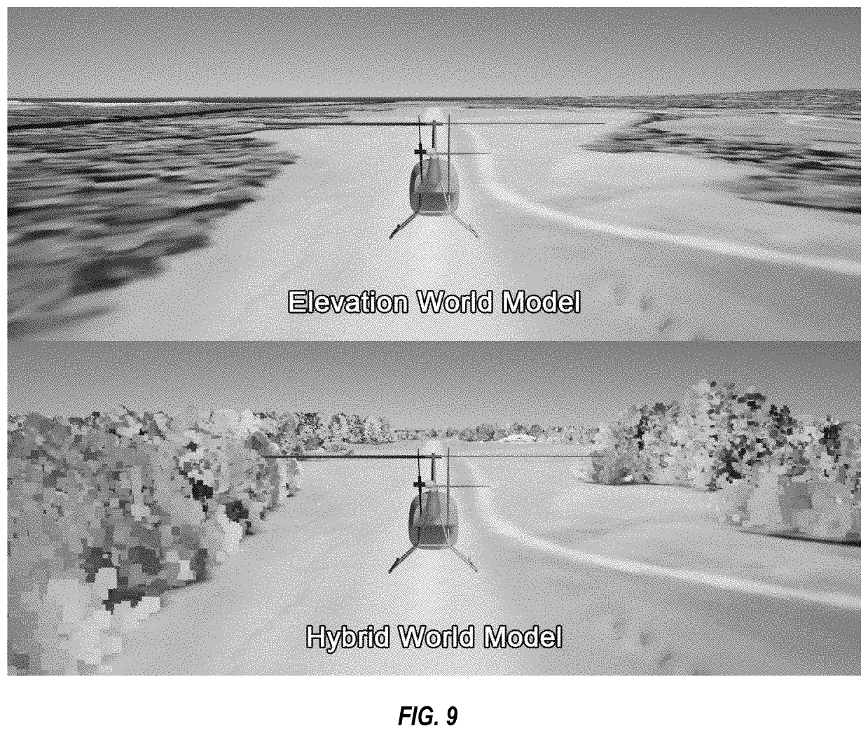

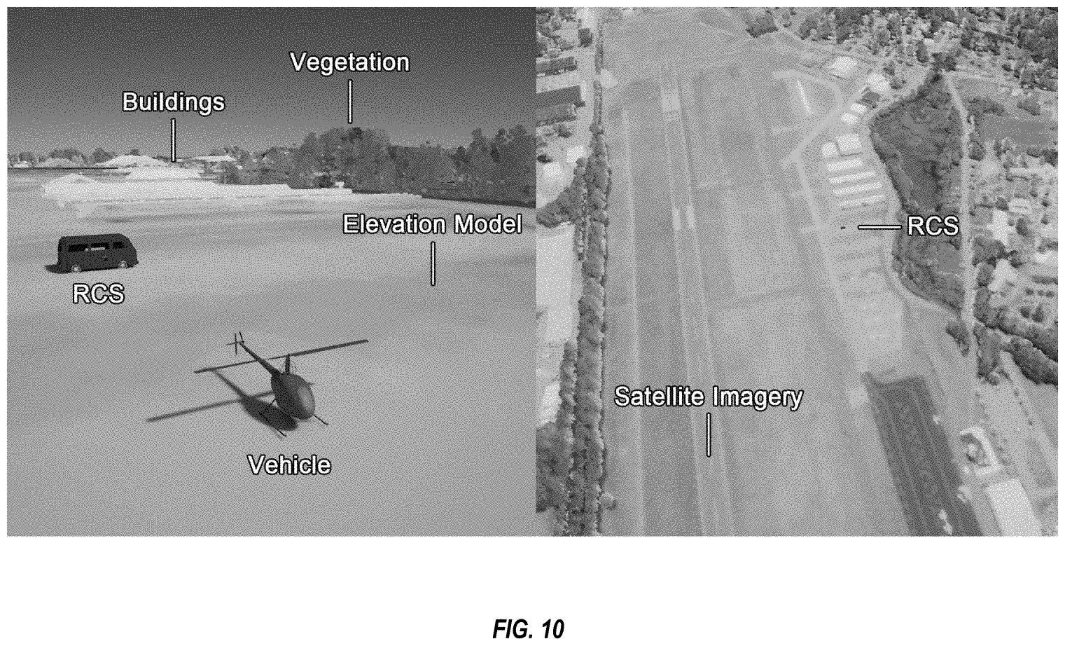

World Model. The Digital Twin and the SVPS may immerse the pilot in a virtual interface that mimics the real world. It is important for the World Model to be as accurate as possible. Multiple sources of data can be aggregated into the final World Model. Satellite imagery, elevation maps, building and road databases, forestry records, and real-time vehicle sensor data may be combined to build the virtual world. The system herein may employ a heterogenous data source approach to improve the accuracy and detail of the World Model. For example, for low flying aerial vehicles, accurate locations of buildings and vegetation are critically important, and these features may not be represented in conventional elevation maps. The system may provide a hybrid World Model with augmented visual object for features critical for piloting aerial vehicles. For example, elevation models may be augmented with aerial point cloud datasets or data derivatives to produce a hybrid World Model that is more appropriate for piloting aerial vehicles. FIG. 9 shows an example of an elevation map without augmentation compared to a hybrid World Model in the context of an aerial vehicle approaching a runway for landing. As shown in the example, vegetation or buildings may be augmented with accurate visual features in the Hybrid World Model as the helicopter is positioned within a proximity from the buildings or vegetation. FIG. 10 shows an example of a hybrid World Model that was generated from heterogenous datasets including digital elevation models (DEMs) for representing terrain, point cloud data and derivatives for representing buildings and vegetation, and satellite imagery for representing landmarks and color.

World Model: Dynamic Updates. The World Model may be updated using Direct Real-time Inputs from onboard the vehicle. In some cases, when the Direct Real-time Inputs do not match with the World Model, or when the World Model uses multiple data sources that conflict, the system may employ conflict resolution method for displaying the information. For instance, a conservative approach may be adopted when displaying the information to ensure safety. For example, if a single tree is detected to be in two different locations according to two separate data sources, both trees may be displayed for the pilot until the inconsistency is resolved (e.g., certainty is above a threshold). In another example, real-time data from onboard sensors may not match one or more features of the World Model, and such real-time data may be used to update the one or more features in the existing World Model, thereby keeping the virtual world up to date with measured conditions. In some cases, the system may execute rule-based programs to determine how frequent the updates need to be performed. For example, rules may be set up such that areas where pilots are flying frequently may be updated more frequently.

World Model: Adaptive Real-time Information. In some cases, the real-time sensor data may be dynamically or adaptively fused based on the availability (e.g., optical camera image may be limited in certain meteorological conditions) or quality of the data. For example, a virtual view of the environment may be provided on the display device based on the stereoscopic video data when the vision information is available. When the vision information is not available (e.g., in IMC or DVE), other non-video data may be utilized to generate the virtual view. In some cases, the onboard processing computer may determine whether the vehicle is in DVE such as by processing the real-time image data, or other sensor data. Upon determining the DVE condition, the camera image data may not be transmitted to the RCS. For example, during night flight or over certain environments, the camera feed may be disabled when the camera input contains no useful information.

World Model: Simplified Data Representation. In some embodiments, the HMI system may be configured to render a virtual view of the World Model based on a combination of real-time sensor data and pre-stored datasets. In some cases, the virtual view may not display the original visual input (e.g., image data) and may be completely virtual. This may beneficially provide situational awareness (SA) to the pilot without distracting the pilot with unnecessary information. The system herein may execute algorithms to determine which visual information is necessary or unnecessary for rendering to the pilot. In some cases, the rendering of an object may be simplified to remove unnecessary details. In some cases, the necessary information may be determined based at least in part on the operating rules (e.g., Visual Flight Rules or Instrument Flight Rules). In some cases, the level of detail of information displayed may be determined based on predetermined rules or based on a trained machine learning model. For example, some details of a building (e.g., architectural details) or details about a tree (e.g., leaves and branches) may not be necessary information for the pilot, but some features of a building such as viable landing areas may be necessary information as they provide the pilot with knowledge of safe landing sites in case of an emergency. The system herein may render a simplified virtual view based on terrain elevation, forestry information, and building data, preserving necessary feature attributes such as shape, dimension, color, and general structure, while omitting unnecessary details. In some cases, one or more real-world features determined to be unnecessary for piloting may not be displayed. Additionally, the virtual view can reduce the amount of data that must be transmitted from the vehicle to the RCS. For example, high fidelity data from onboard cameras may be processed by an onboard computer which can detect objects and their relative positions. Instead of sending back the full, raw camera feed, a subset of detected objects that are determined to be necessary may be sent to the RCS and visualized in the SVS display thereby reducing the payload. For example, upon detecting one or more objects that are necessary for flight under VFR or IFR conditions, information about the objects such as moving speed, location, size, dimension, and/or classification may be sent to the RCS and rendered in real-time in the SVS display utilizing pre-stored 3D models. In IMC or DVE conditions, optical camera image data may not be processed, transmitted, and visualized in the SVS display. Alternatively or additionally, image data of the one or more features may be transmitted to the remote station and may be processed to render a virtual view of the one or more features.

Views, HUDs, and Overlays. The immersive SVPS may render visual graphics regarding vehicle telemetry and environment information in an intuitive manner using Views, HUDs, and Overlays. In some embodiments, the Views feature may provide the pilot with the visual perspective that they may assume when operating the vehicle. The SVS display may allow multiple viewing angles and perspectives simultaneously, including First Person View (FPV) and Third Person View (TPV) options. A major advantage of the SVPS over traditional in-vehicle piloting is that views can be generated without any occlusions and from viewing perspectives that would be impossible for in-vehicle pilots (e.g., TPV). For example, any obstruction of the in-vehicle view due to the vehicle itself (e.g., limited window size) may be eliminated from the Views. Heads Up Displays (HUDs) overlay information in the pilot's visual field of view. Information that may be included in the HUD display may include vehicle telemetry, such as numeric data (e.g., RPMs, speeds, altitude) or visual data (e.g. artificial horizon, aircraft angle). Overlays may be used to display information that is applied to the environment in the world reference frame. For example, overlays may include sensor data, vehicle projections, weather data, points of interest, sectional data, etc. Moreover, HUDs display information in fixed positions relative to the pilot's view, where overlays display information in the world frame. Views, HUDs, and overlays may be configurable via software controls to meet the requirements of the vehicle, the mission objectives, and pilot preferences. Additional details regarding these visual frameworks are described later herein.

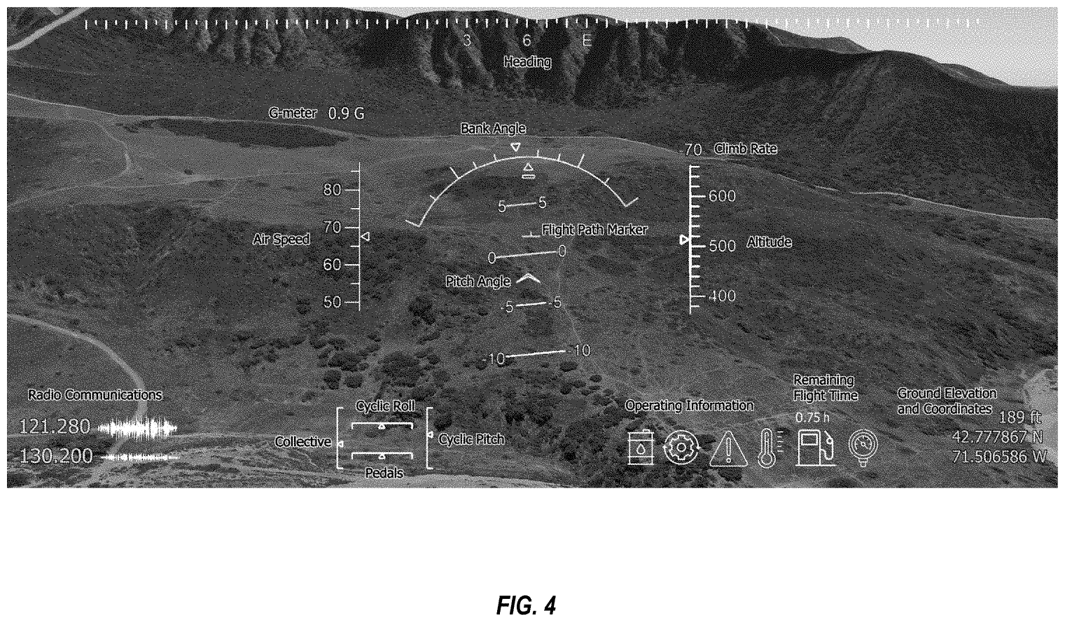

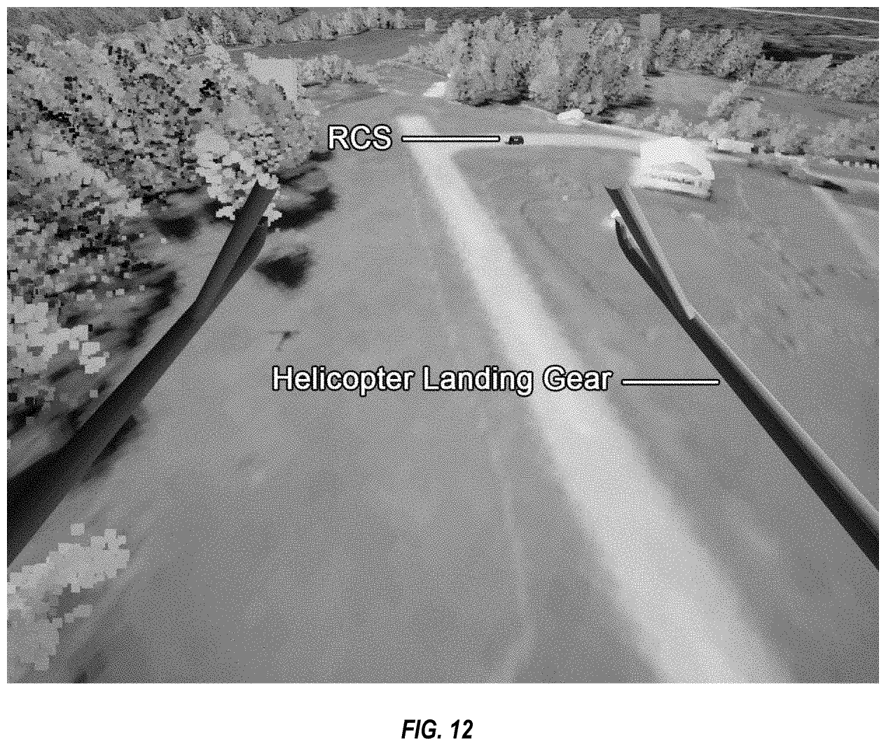

First Person View (FPV). The SVPS may enable the pilot to operate the vehicle in First Person View (FPV). The FPV may be rendered in a position that mimics the traditional cockpit location on the vehicle, or the FPV can be rendered in a non-traditional location relative to the vehicle frame. In some cases, Non-traditional perspectives for FPV may include view angles and positions that are not possible for conventional in-vehicle piloting, such as a rearward-facing view positioned at the back of the vehicle, or a downward-facing view positioned at the bottom of the vehicle. FIG. 12 shows an example of a non-traditional FPV perspective that shows a downward-facing view at the bottom of an aerial vehicle such that the view includes a rendering of the vehicle's landing gear. The FPV may render the virtual view without any obstructions or occlusions that would be created from by the vehicle and/or the pilot in traditional in-vehicle operations. This ability to render views that are occlusion-free may increase the situational awareness of the pilot. The FPV may be combined with specific HUD and overlay settings to optimize the situational awareness for the pilot, enable operation in specific environment conditions, and cater to pilot preferences. FIG. 4 shows an example FPV with corresponding HUD elements for an aerial vehicle.

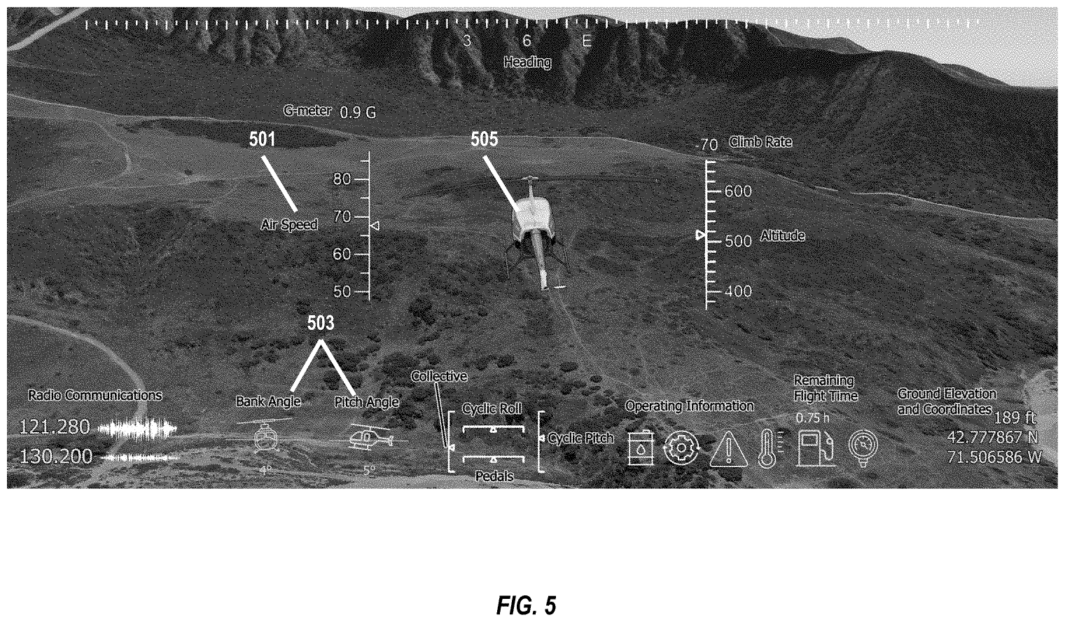

Third Person View (TPV). The SVPS may enable the pilot to operate the vehicle in Third Person View (TPV). The TPV includes within the SVS display a 3D model of the vehicle, allowing the pilot to see the extent of the vehicle in relation to its environment. This 3D model is rendered from an external virtual perspective that may follow the vehicle around as it moves through the environment. The relative location of the TPV perspective, as well as the dynamics of vehicle-following, may be configurable by the pilot. The TPV allows the pilot to have a greater sense of vehicle awareness as they move through 3D space. TPV mode can greatly increase pilot situational awareness and enable more precise maneuvering, particularly in tight spaces or during fast maneuvers relative movement. FIG. 5 shows an example TPV with corresponding HUD elements 501, 503 for an aerial vehicle. As illustrated in the example, the HUD elements 501, 503 may include, for example, airspeed, altitude, claim rate, heading, ground elevation and coordinates, vehicle orientation (e.g., Pitch angle) and/or other information as described elsewhere herein. The TPV may include within the SVS a display of a 3D model of the vehicle 505, allowing the pilot to see the extent of the vehicle in relation to its environment. In the illustrated view, the 3D model is rendered from an external virtual camera view point that “follows” the vehicle around as it moves through the environment. This allows the pilot to have a greater sense of vehicle awareness as they move through 3D space.

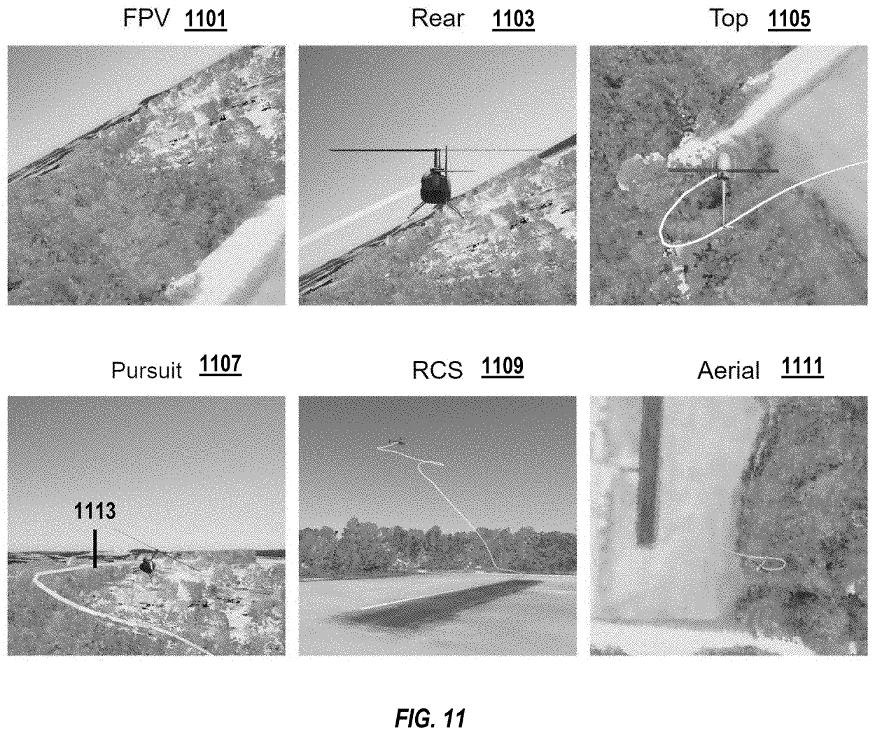

Third Person View: Camera Location. The SVPS system may allow the pilot to manipulate the TPV perspective rendered in the SVS display. For example, the virtual camera through which the pilot is looking can be placed in any user-selected location around the vehicle. For instance, the virtual camera can be placed behind the vehicle to provide greater awareness of surroundings, close to the bottom of the vehicle to help gauge distance from the ground, or from a static location in the environment to mimic the perspective of a remote observer. The pilot may be able to update or change the angle and position of the TPV using pan, tilt, and translation controls. In some cases, a set of virtual TPV cameras may be available to the pilot in predefined locations relative the vehicle, and the pilot may have the flexibility to switch between the different views as necessary to adapt to mission requirements or pilot preferences. FIG. 11 shows an example of different views that may be available to the pilot during operations. The example shows an FPV 1101 from an aerial vehicle, and various different TPV perspectives including a rear view 1103, a top view 1105, a pursuit view 1107, an RCS view 1109 and an aerial view 1111. Some TPV perspectives dynamically follow the vehicle as it navigates through the environment (e.g., “Rear” 1103, “Top” 1105, and “Pursuit” view 1107) while other TPV perspectives may be placed in static locations in the environment (e.g., “RCS” 1109, and “Aerial” view 1111).

Third Person View: Vehicle Following Mode. The SVPS may allow different dynamics for vehicle-following behaviors in the TPV perspective. The TPV may comprise a view that translates and rotates rigidly with the motion of the vehicle such that the view is always in a fixed position and orientation relative to the vehicle, which is referred to as “rigid following mode”. This rigid following mode may beneficially allow the pilot to gain accurate situational awareness of vehicle rotations, including pitch, roll, and yaw, which is important for aerial vehicles. Alternatively, the TPV may comprise a view that follows the vehicle with de-coupled dynamics which may allow for preservation of certain viewing properties independently of vehicle dynamics, which is referred to as “pursuit following mode”. For example, the TPV may utilize a pursuit following mode that follows the vehicle, keeping the vehicle in the center of the view while maintaining level flight (e.g., the TPV view does not match the pitch and roll of vehicle). The pursuit following mode may beneficially allow the pilot to pay more attention to the surrounding environment, such as in remote sensing operations. FIG. 11 shows an example of different TPV vehicle-following modes, including rigid following (e.g., “Rear” view 1103) and pursuit-following (e.g., “Pursuit” view 1107). Due to the parallax induced by the shift in virtual camera location away from the center of rotation of the vehicle in pursuit following mode, the pitch and roll indicators in the HUD may be utilized to accurately convey pitch and roll information to the pilot. An example illustrated in FIG. 5 shows icons of the vehicle with bank angle and pitch angle 503 in the viewport to provide the pitch and roll information of the Vehicle. In some cases, pitch and roll visualizations may be provided in a visual intuitive manner. For example, a level ring may be rendered around the 3D model along with a counterpart ring that pitches and rolls with the airframe. The alignment of these rings may help indicate the orientation of the vehicle to the pilot in a visually intuitive manner.

Third Person View: Digital Twin of Vehicle. In addition to increasing the pilot's awareness of the vehicle's surroundings, the TPV may also increase the pilot's awareness of the vehicle itself by leveraging a Vehicle Digital Twin. Analogous to the Digital Twin used to construct the World Model, the Vehicle Digital Twin is a virtual representation of vehicle state. This allows the 3D model of the vehicle to mimic the realistic conditions of the aircraft and then display them to the pilot. For example, based on the operational status, indicators, and sensor data from the vehicle, the components of the virtual vehicle such as the lights, gear, flaps, blades, and the like may be rendered to reflect the corresponding components of the real vehicle. Additionally, more complex features such as vehicle aerodynamic conditions may be simulated based on Real-time Inputs and then visually rendered to the pilot as part of the Vehicle Digital Twin. For example, for a helicopter, the SVPS may display aerodynamic conditions such as dissymmetry of lift, stall regions, vortex ring states, and loss of tail rotor effectiveness due to wingtip vortices. These aerodynamic conditions can be dangerous for helicopter operations, thus adding the ability to visualize these conditions may beneficially improve a critical aspect of the pilot's situational awareness. Such aerodynamic conditions may be rendered in a format that is intuitive to a user. For example, the aerodynamic conditions may be displayed in texts, icons, graphical elements, and/or animations, etc. Along with the aerodynamic conditions corresponding to the vehicle, the Vehicle Digital Twin may also allow for visualization of the vehicle's state history in the SVS display. For example, a transparent trace of vehicle's position history may be rendered as the vehicle navigates through the environment. FIG. 11 shows an example of rendered vehicle traces 1113 for an aerial vehicle from several different views.

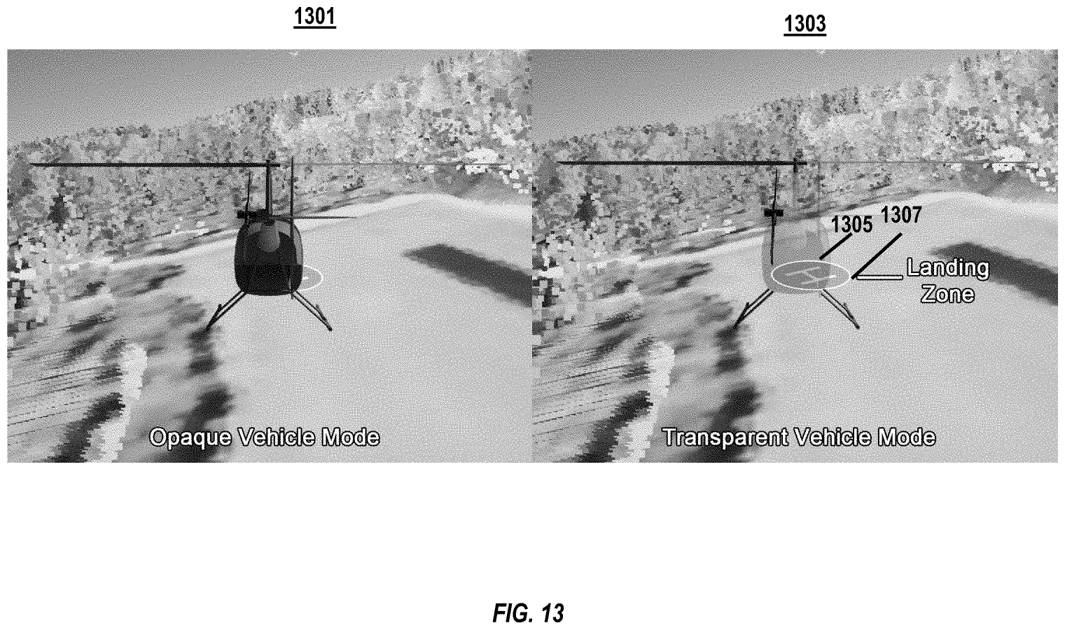

Third Person View: Transparent Vehicle Mode. When operating the vehicle in TPV, an opaquely rendered vehicle may occlude important regions of the environment from the pilot. To overcome this potential limitation in TPV, the SVPS may allow for a transparent rendering mode that visualizes a transparent 3D vehicle model instead of an opaque model. The vehicle transparency mode may be automatically deployed during specific operations conditions. For example, during a landing procedure for an aerial vehicle, the transparency mode may be automatically activated when the aerial vehicle is detected to be within a proximity of the landing destination (e.g., within certain altitude, height, distance, etc.) such that rendering of the vehicle may change to transparent (e.g., 10% transparency, 20% transparency, 30% transparency, etc.). Alternatively or additionally, the vehicle transparency mode may be dynamically selected by the pilot based on their preferences. FIG. 13 shows examples of a vehicle rendering in an opaque mode 1301 and a transparent mode 1303. As shown in the example, the vehicle rendering for an aerial vehicle 1305 may turn to transparent when it is approaching a landing zone 1307. The transparent vehicle mode may beneficially increase the pilot's ability to control a vehicle in TPV in certain operating conditions.

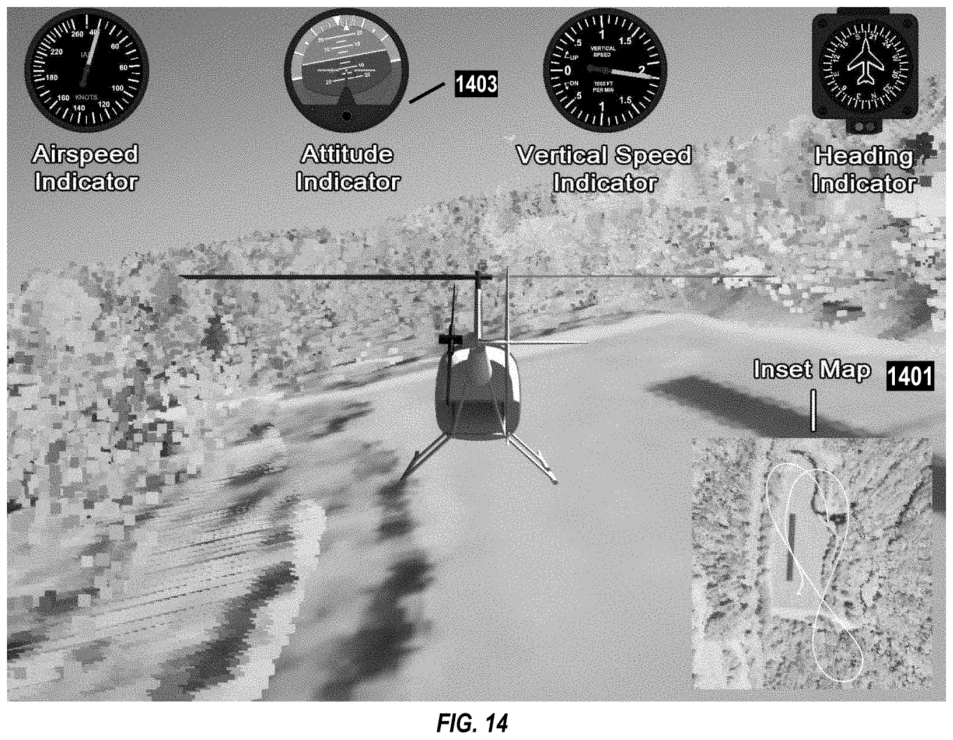

Heads Up Display (HUD). A Heads Up Display (HUD) may display important information in the pilot's field of vision as a persistent overlay in the SVS display. This beneficially allows a pilot to maintain greater situational awareness without having to look outside the SVPS. In some embodiments, a fully integrated SVPS may not comprise an instrument panel (neither physical nor rendered) and all relevant flight information may be provided in the HUD as numerical or other visual elements. In some embodiments, virtual flight instruments may be included in the HUD. In some cases, flight control inputs may be received via external input devices such as joysticks and pedals. Users may use suitable input devices such as via external controllers with directional inputs and buttons to interact with the HUD. In some cases, when a VR or AR system is utilized, the user command may be provided by hand gesture or motion detection through virtual interactions. FIG. 4 and FIG. 5 show examples of HUD screens for an aerial vehicle in FPV and TPV, respectively. These HUDs convey important information such as airspeed, altitude, heading, and vehicle orientation, without the need for conventional flight instrument panels. As illustrated, these metrics are visualized using geometric shapes and ticked lines that scroll across the HUD. Scrolling ranges for airspeed and altitude may give the pilot a better sense of how quickly the values are changing as they maneuver the vehicle. Adjacent to the center view, the pilot may have access to general vehicle information such as control inputs, control mode (e.g., AI Mode, Remote Pilot Mode, stability augmentation system (SAS) mode), engine state, flight time, fuel consumption, location, ground elevation, weather data, radio channels, and vehicle warnings. Vehicle states that are expected to stay within a certain operating range may be simplified such that they are only displayed in full if they are outside the expected envelope/range. This reduces clutter in the HUD and improves noticeability when the vehicle is operating outside of the expected ranges. FIG. 14 shows another example of a TPV with HUD display. In this example, the HUD contains graphics that mimic traditional flight instruments 1403 along with an inset aerial map view 1401. The traditional flight instruments 1403 may beneficially leverage prior in-vehicle piloting experience, and the inset aerial map 1401 highlights the flexibility of SVS display, where multiple views can be simultaneously displayed to the pilot to improve situational awareness.

HUD: VFR and IFR Flight. The visual information displayed on the HUD of the SVPS display may permit aircraft to fly in either VFR or IFR conditions, as defined by the FAA or other applicable governing body. For instance, the information for VFR flight may include airspeed, altitude, heading, engine RPMs, oil pressure, engine temperature, oil temperature, manifold pressure, fuel quantity, and landing gear position. Additional information needed for IFR may include radio communication frequencies, rate of turn, slip/skid turn feedback, time, pitch, bank, direction, weather data, airport visibility restrictions, and potential landing locations.

HUD: Panning. The HUD can operate in a panning mode or a fixed mode. In the panning mode, the HUD may remain attached to the pilot's field of view as they look around the display screen. In the fixed mode, the HUD will remain centered towards the front of the vehicle. Different elements of the HUD can exist in different modes depending on pilot preferences.

HUD: Configurability. HUD features can be toggled on or off according to the flight, mission, and pilot requirements. They can also be rearranged prior to the flight in a configuration tool or during the flight using controls accessible to the pilot (e.g., hands-on-throttle-and-stick tools).

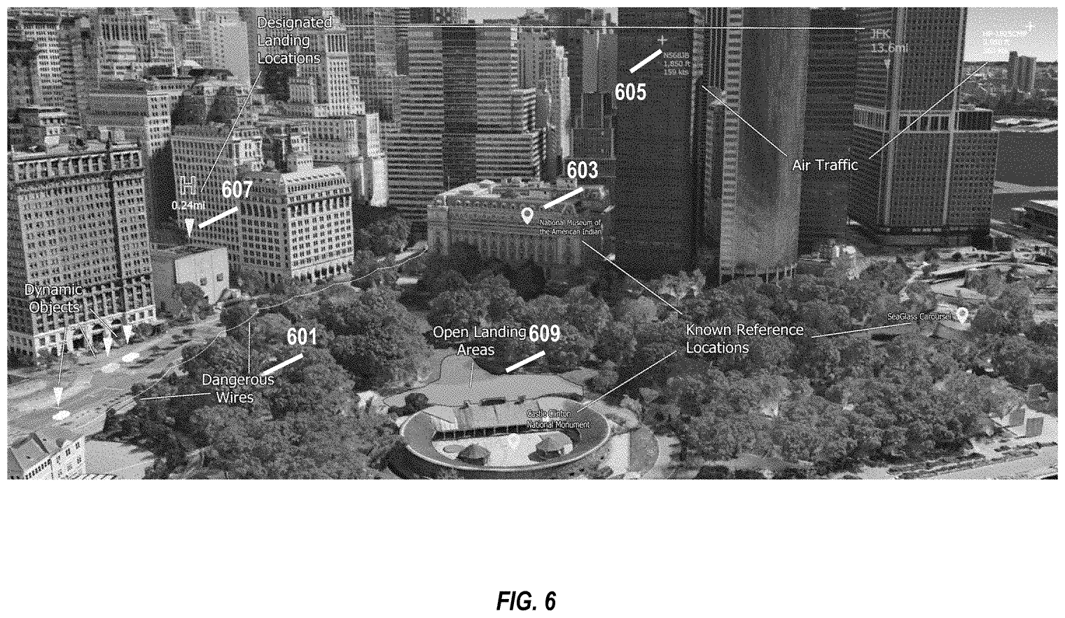

Overlay: The synthetic vision display in the SVPS allows the overlay of useful information in the environment. Unlike HUD elements which are rendered at fixed locations in the virtual view, overlays are applied to the environment, which have fixed (e.g., landmarks) or moving (e.g., other vehicles) positions in an absolute or world reference frame. The overlay of visual features may provide information necessary or useful for piloting a vehicle. In some cases, systems herein may determine the information to be presented in an overlaying layer based on predetermined rules or utilizing a machine learning algorithm trained model. In some cases, the system may determine what information is necessary for display on the fly. The necessary information may be associated with hazards that the vehicle may want to avoid, structures that can be used as potential landing areas, navigation indicators, and/or landmarks (e.g., landmarks that can be used as reference). FIG. 6 shows examples of markers for Places of Interest 603 and Hazards 601 in an urban environment. As shown in the example, the markers may be displayed for landmark 603s, other air traffic 605, helipads, suitable landing areas 607, 609, power lines 601, and ground vehicles.

Overlay: Points of Interest. The HMI display may allow Points of Interest to be overlaid in the pilot's view. This can include landmarks, landing areas, waypoints, and other spatial data related to mission objectives. Landmarks are well known areas that can be used as references when coordinating with other pilots or ground units. Suitable landing areas provide the pilot with safe areas to land in case of an emergency. Overlays of helipads and airports may beneficially allow pilots to navigate to their destination 607 more effectively or select safe landing areas 609 in an emergency. In some embodiments, a sequence of waypoints may represent the pre-planned path for the pilot to follow during the mission (e.g., highway in the sky, path in the sky).

Overlay: Hazards. In some cases, artificial objects and/or overlaid information may indicate hazardous conditions. For instance, visual warning indicators for wires and power lines 601 may be rendered in the virtual view, both of which are major safety risks for aerial vehicles. High tension cables are difficult to see during flight and can lead to fatal accidents in the event of collision. Since the wires themselves are difficult to see, pilots are often trained to look for accompanying poles where the cables are attached. The SVS display may highlight the poles and wires with a distinguishable overlay to help pilot identify and avoid these hazards. Areas free of hazards such as wires, trees, and other obstacles can then be displayed as potential landing zones as well.

Overlay: Air and Ground Traffic. Air traffic and ground traffic may be displayed or highlighted in an overlay to improve visibility and awareness. Information 605 may be displayed as visual tags which move along with the traffic itself, along with information about their callsign, altitude, speed, direction, and vehicle type. This information can be used to avoid collisions with other vehicles and enable coordination with traffic controllers or other pilots. Additionally, predicted state information of air traffic may be displayed in the overlay, which can also be used for collision avoidance and route planning. For example, the predicted state information may be used to predict and display the potential flight or ground paths of other traffic. This can provide a short-term, dynamic mapping of areas that should be approached with caution.

Overlay: Ground Traffic and Ground Objects. Dynamic or static ground objects can also be displayed to the pilot in the SVS display using an overlay. Sensors onboard the vehicle and prestored environment data can be rendered in the SVS display to communicate nearby objects to the pilot. These objects can include ground crews with whom the pilot needs to coordinate or unknown objects that the pilot needs to avoid. The speed and direction of moving objects can also be displayed along with an indication of their expected trajectory. This predictive information may help the pilot avoid collisions and perform route planning.

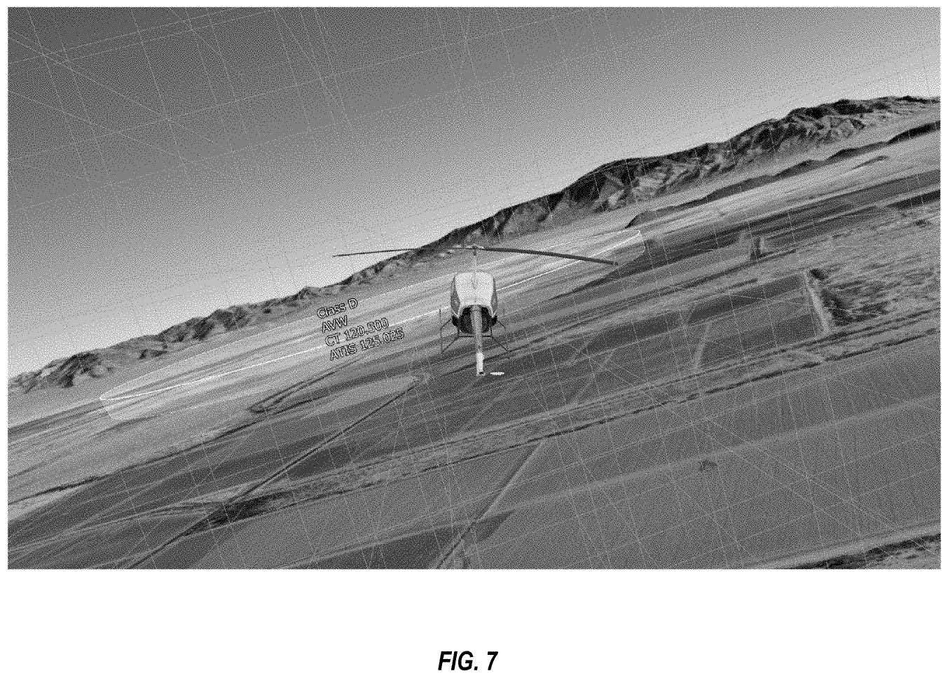

Overlay: Airspace. Different classes of airspace exist in different geographic areas and altitudes, with multiple classes of airspace often overlapping the same land area at different altitudes. This information is typically tracked by pilots on a 2D map and the vehicle's altitude is used to determine when the pilot is entering a specific airspace. In a 3D synthetic environment, the full 3D outline of nearby airspaces may be displayed directly to the pilot in an overlay. Information about the airspace may also be displayed such as the type of airspace, the altitudes of each level, and the radio frequencies that the pilot needs to use to enter the airspace. The visualization of these airspaces may help the pilot avoid areas that they are not allowed to fly through. Temporary Flight Restrictions are no-fly zones that are in place for a limited time during special events. These zones may be displayed in the same manner as other airspaces, allowing pilots to avoid these restricted areas. An example of an airspace overlay is shown in FIG. 7. FIG. 7 shows an overlay that highlights a Class D airspace zone as well as providing visual reference grids for terrain, water, and free space.

Overlay: Sectional Information. In the case of aircraft piloting, pilots rely on Sectional Charts to navigate and aviate. The overlays in the SVPS can include all of the information contained in a Sectional Chart to allow aircraft pilots to perform all of their navigational and flight duties from within the SVS display.

Overlay: Open Air Grid. A synthetic vision environment can provide virtual references when the vehicle is far from any real-world objects. Grid lines portrayed in open air can give the pilot a better reference for how the vehicle is moving through space, especially in the absence of other reference points. FIG. 7 shows an example of a virtual reference open air grid. This can make it easier for pilots to maintain their heading and altitude in windy conditions and can facilitate hovering when far from the ground. Since the grid lines are virtual, they can also be displayed in any direction. For example, a pilot may prefer to configure the lines to be oriented towards the pilot's destination. These lines may also display information about the environment through color-coding, line thickness, or directional arrows. For instance, moving, colored patterns along the grid may indicate wind direction so pilots can visualize the velocity of the air around them. Since wind can change drastically from one altitude to the next, this overlay can help pilots find altitudes with preferable wind conditions for their flight.

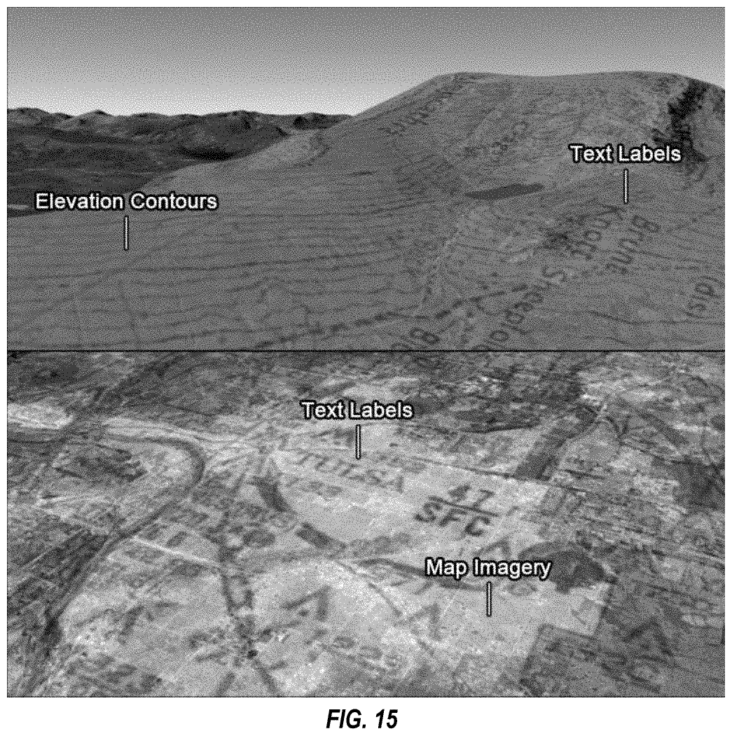

Overlay: Ground Reference and Terrain Grid. Similar to the open-air grid, a grid of coordinates or 2D map data can be overlayed across the terrain to improve navigation and orientation awareness. The overlay may include grid lines, latitude and longitude markings, elevation contours, text labels, or other map imagery. In some cases, the grid lines may converge on specific destinations, display latitude and longitude coordinates, show elevation contours, or be aligned with runways to allow for easier approaches. The synthetic objects in the ground reference overlay may comprise any suitable geometric shapes. In some cases, the synthetic objects may be rendered in the form of a natural object such as trees, poles, or waves. In some cases, such natural object may not exist in the real environment or visible in the real-time environment while displaying such synthetic objects may beneficially provide reference points to the pilot. FIG. 15 shows an example of a Ground Reference Overlay, including elevation contours, text labels, and map imagery. These types of ground references and terrain grids can be displayed during IFR conditions, providing the pilot with a visual reference to the ground and surrounding environment. This may beneficially allow pilots to perform terrain-following operations at night and in DVE conditions. In another example, the overlays can improve brown-out or white-out conditions when a rotorcraft kicks up dust or snow during landing. Typically these conditions result in dangerous situations since the in-vehicle pilot may lose their reference to the ground. However, with SVS display overlays, the pilot may maintain a ground reference despite DVE conditions during landing.

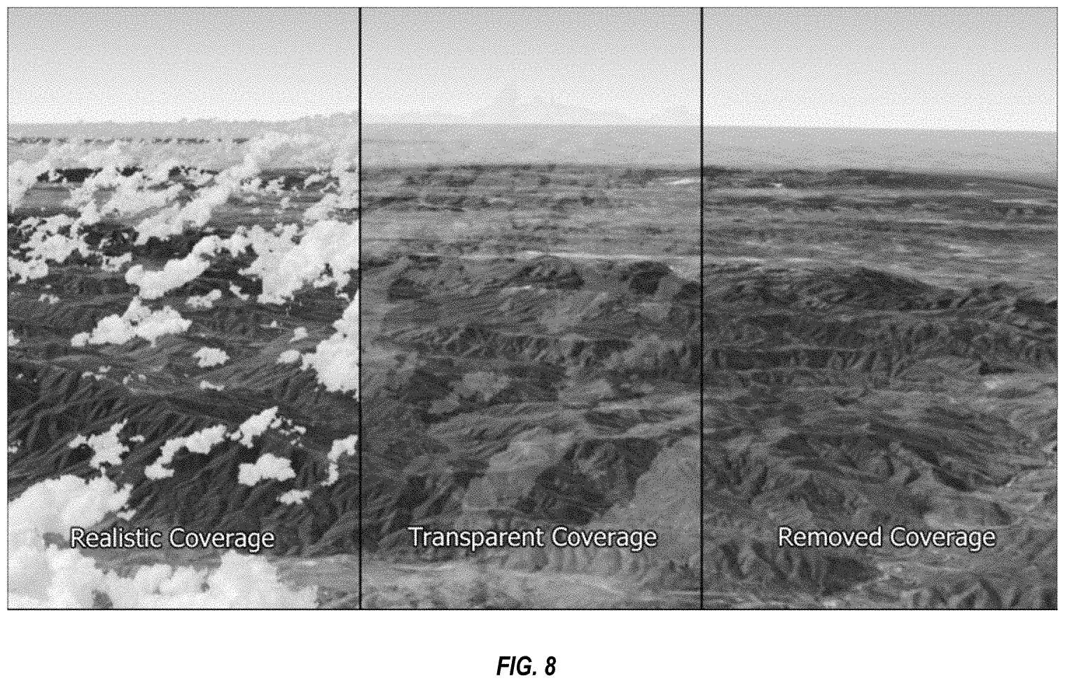

Overlay: Weather Display. In a fully integrated synthetic environment, the weather and lighting can be rendered in any suitable manner and can be configurable. FIG. 8 shows the ability to modify the display of weather and other environmental conditions (e.g., lighting conditions) to match current conditions or to maximize pilot situational awareness. Conditions such as the position of the sun and opacity of clouds can be adjusted as desired or automatically based on the detected vehicle position. Distant weather conditions may be displayed so the pilot can be aware of large storms, foggy valleys, or cloudy areas where icing might occur. If the pilot needs to fly into such an area, the clouds can be made transparent so that the pilot does not suffer any degradation in visibility.

Overlay: Environmental Lighting. The environmental lighting can be used to improve the pilot's awareness. Lighting can mimic the real world so the pilot can reference shadows and the sun direction if necessary. Alternatively, the lighting may not be configured to be photorealistic if it does not support the pilot's ability to perform the mission. Real world lighting effects such as sun glare and reflections may be eliminated to increase pilot visibility. In some cases, the sun may be rendered anywhere in the sky. For example, the sun could be positioned in the northern part of the sky even if the pilot is flying in the northern hemisphere and the sun should be in the south. Shadows can be disabled so there are no dark areas around buildings and valleys. More than one light source can even be used to produce multiple vehicle shadows if they are useful references when landing or flying near objects.

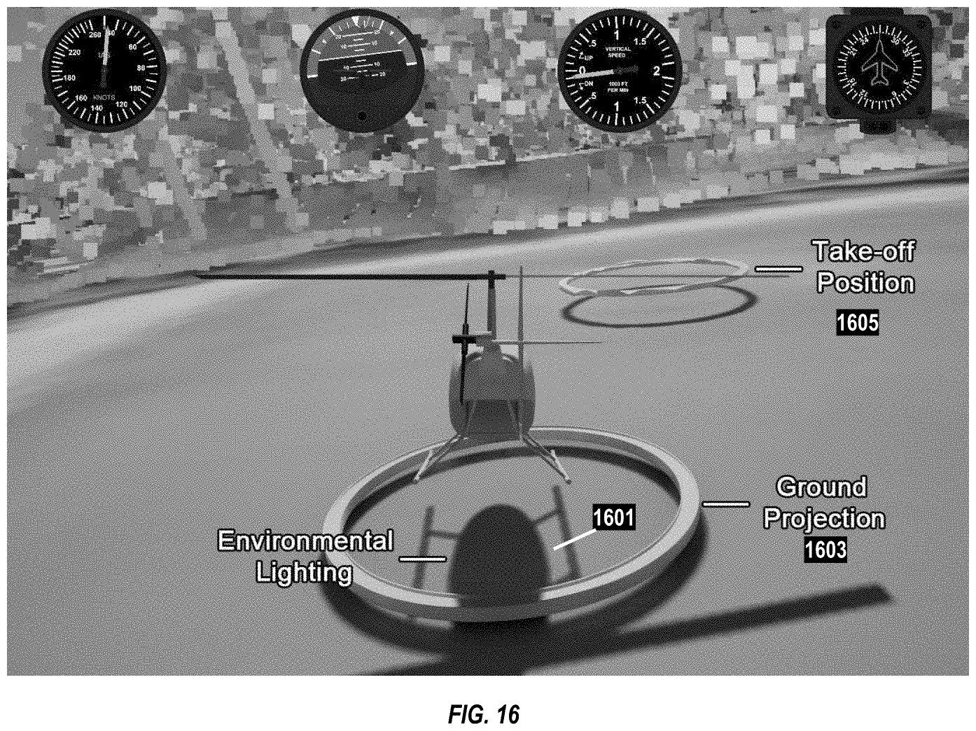

Overlay: Vehicle Location Projections. The ground projection of the vehicle may be included in an overlay. For example, position of the vehicle projected directly below it onto the ground may be displayed as an artificial shadow or marker with no “parallax” (as would be the case with a real shadow). This may help pilots to land an aerial vehicle at a precise location. The vehicle's location may also be projected in other directions or onto other surfaces (e.g. onto the side of a mountain range) to show the relative altitude of the vehicle, and may support accurate positioning and collision avoidance. The projection may be visualized using shadows, lines, or other visual markers. Additionally, other notable reference points such as the vehicle's start position or take-off position may be visualized in the SVS display in a similar manner to the ground projection marker. FIG. 16 shows an example of ground projection 1603 and take-off position overlays 1605, as well as a vehicle shadow 1601 generated by environmental lighting.

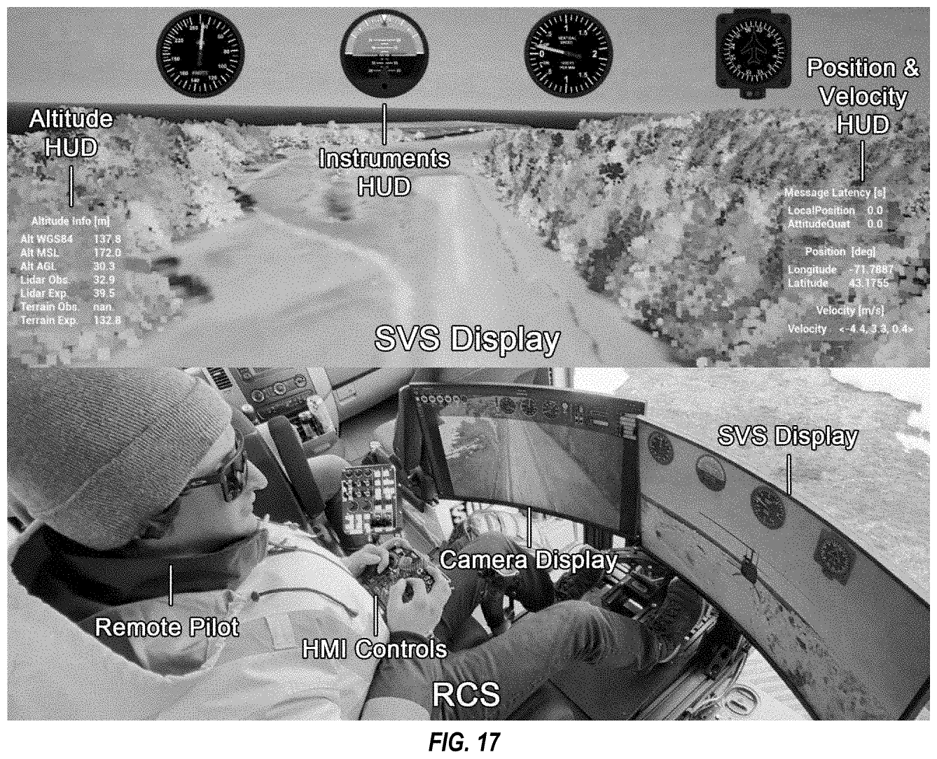

The present disclosure provides a synthetic vision piloting system (SVPS), an immersive HMI that improves pilot situational awareness compared to conventional in-vehicle methods and enables vehicle operation in challenging conditions such as degraded visual environments (DVE). FIG. 17 shows an example of a Remote Pilot actively piloting a subscale aircraft with the SVPS. The figure shows an SVS display in FPV perspective (top) and the inside of an RCS (bottom) where the Remote Pilot utilizes the SVS display to operate the vehicle. During the flight, the Remote Pilot operates the subscale aircraft beyond traditional limits.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. Numerous different combinations of embodiments described herein are possible, and such combinations are considered part of the present disclosure. In addition, all features discussed in connection with any one embodiment herein can be readily adapted for use in other embodiments herein. It is intended that the following claims define the scope of the invention and that methods and structures within the scope of these claims and their equivalents be covered thereby.

1. A system for providing synthetic vision to a human operator, the system comprising:
a display device disposed at a control station remote from a movable object capable of translational and rotational movement;
one or more processors configured to perform operations including:
receiving real-time data from one or more data sources and accessing data stored in a local or cloud storage device to construct a virtual view; and
rendering the virtual view to the human operator via the display device for controlling an operation of the movable object under Visual Flight Rules (VFR) condition or Instrument Flight Rules (IFR) condition,
wherein the virtual view comprises a first-person view (FPV) or a third-person view (TPV) and wherein either the FPV or the TPV comprises at least a rendering of a natural object serving as a reference point to the human operator.

2. The system of claim 1, wherein the movable object comprises a fly-by-wire control system for controlling an actuator of the movable object in response to a command received from the control station.

3. The system of claim 2, wherein the movable object is a helicopter.

4. The system of claim 1, wherein the virtual view is displayed based on measurements of a movement of the human operator's head and/or eyes.

5. The system of claim 1, wherein the real-time data comprise video stream captured by an imaging device onboard the movable object and wherein the natural object is not visible in the video stream.

6. The system of claim 1, wherein the operations further include determining data to be displayed within the virtual view based on the VFR condition or the IFT condition.

7. The system of claim 1, wherein the TPV is configurable by changing a virtual TPV camera location.

8. The system of claim 1, wherein the operations further include activating a transparency mode in the TPV when the movable object is approaching a destination.

9. The system of claim 1, wherein the virtual view comprises a rendering of a dynamic obstacle.

10. The system of claim 9, wherein the dynamic obstacle is tracked by processing sensor data collected from movable object.

11. The system of claim 10, wherein a location of the dynamic obstacle is tracked by applying a feed-forward model to the sensor data.

12. The system of claim 11, wherein an identity of the dynamic obstacle is determined by applying a machine learning algorithm trained model to the sensor data.

13. The system of claim 12, wherein the rendering of the dynamic obstacle is based at least in part on a certainty of the identity and/or the location.

14. A method for providing synthetic vision to a human operator, the method comprising:
providing a display device at a control station remote from a movable object capable of translational and rotational movement;
receiving real-time data from one or more data sources and accessing data stored in a local or cloud storage device to construct a virtual view; and
rendering the virtual view to the human operator via the display device for controlling an operation of the movable object under Visual Flight Rules (VFR) condition or Instrument Flight Rules (IFR) condition,
wherein the virtual view comprises a first-person view (FPV) or a third-person view (TPV) and wherein either the FPV or the TPV comprises at least a rendering of a natural object serving as a reference point to the human operator.

15. The method of claim 14, wherein the movable object comprises a fly-by-wire control system for controlling an actuator of the movable object in response to a command received from the control station.

16. The method of claim 15, wherein the movable object is a helicopter.

17. The method of claim 14, wherein the virtual view is displayed based on measurements of a movement of the human operator's head and/or eyes.

18. The method of claim 14, wherein the real-time data comprise video stream captured by an imaging device onboard the movable object and wherein the natural object is not visible in the video stream.

19. The method of claim 14, further comprising determining data to be displayed within the virtual view based on the VFR condition or the IFT condition.

20. The method of claim 14, wherein the TPV is configurable by changing a virtual TPV camera location.
